(19) United States
(12) Patent Application Publication
(10) Pub. No.: US 2003/0101426 A1
(43) Pub. Date: May 29, 2003

(54) System and method for providing isolated fabric interface in high-speed network switching and routing platforms

(75) Inventors: Scott A. Sarkinen, Mounds View, MN (US); Jeffrey D. Swart, Eden Prairie, MN (US); Neil A. Schlegel, Lino Lakes, MN (US); Jerome M. Meyer, Chanhassen, MN (US); David L. Hollinrake, Brooklyn Park, MN (US)

Correspondence Address: Scott Sarkinen, 7580 Knollwood Drive, Mounds View, MN, 55112, US

(73) Assignee: Terago Communications, Inc., Maple Grove, MN

(21) Appl. No.: 09/995,410

(22) Filed: Nov. 27, 2001

(51) Int. Cl. G06F 17/50

(52) U.S. Cl. 716/12

(57) ABSTRACT

A system and method for interfacing network elements using an isolated fabric interface module, which is facilitated through exploitation of standards otherwise not specified for the particular networking functions in which they are utilized. Fabric interface functionality is isolated and independent of line and switch fabric cards. Standards otherwise suitable for use in interfacing network elements are adapted for use in the isolated fabric interface configuration. The standard interfaces are adapted to extend beyond the specified length, signal traces are routed according to predetermined routing rules using matched impedance connectors, and signals are terminated to facilitate the length extension. Standard system controllers may also be used although the controlled line cards are not compliant with the standard. A network switching/routing element having a discrete fabric interface module can thus be designed using known standards, while effectively allowing the standards to operate at non-specified parameters.

### CROSS-REFERENCE TO OTHER PATENT APPLICATIONS

The following co-pending patent applications of common assignee contains some common disclosure:

“Multi-Service Queuing Method And Apparatus That Provides Exhaustive Arbitration, Load Balancing, And Support For Rapid Port Failover”, Attorney Docket No. 1305.20-US-01, filed on Sep. 21, 2001, which is incorporated herein by reference in its entirety.

### FIELD OF THE INVENTION

This invention relates in general to communication networks, and more particularly to a system and method for isolating network switching/routing interface functions and facilitating such an isolated interface through exploitation of standards adapted, but otherwise not specified for, the particular networking functions in which they are implemented.

### BACKGROUND OF THE INVENTION

The global proliferation of communications networks has perpetuated a frenzied effort to increase bandwidth and functionality. The tremendous increase in data transmission demands continues to push the networking bandwidth envelope to capacity. As bandwidth-intensive multimedia content increasingly becomes the norm in communications, the unrelenting bandwidth dilemma is not easily mitigated. This demand has fueled the need for high-bandwidth broadband systems.

The term “broadband” has often been used to describe high-bandwidth transmission of data signals, such as data, video, voice, video conferencing, etc. Broadband philosophies often address networking principles applicable to the backbone of the networking system, since the networking backbone generally faces the highest bandwidth demands. There are many competing technologies for delivering broadband access. For example, there are a number of methodologies used in digital telecommunications, including TCP/IP, Ethernet, HDLC, ISDN, ATM, X.25, Frame Relay, Digital Data Service, FDDI (Fiber Distributed Data Interface), T1, xDSL, Wireless, Cable Modems, and Satellite among others.

Broadband communication necessitates an infrastructure capable of delivering and routing massive quantities of information. The backbone network for broadband communications is a high speed physical network that spans large distances, connecting smaller regional networks. As part of the backbone, high-capacity switches and routers are employed to handle the high volume switching and routing functions required to move data to the targeted destinations. The largest routers, those used to handle data at the major traffic points on the Internet, are generally large stand-alone systems that handle millions of data packets every second and work to configure the network most efficiently. Routers and switches are also used at the lower level networks, including regional networks, metropolitan networks, and even down to office local area networks.

High-speed network routers include line cards to provide an interface for the data, and also include a switch fabric to switch the data to a line card port associated with the redirected target destination. Conventionally, the interface between the line cards and the switch fabric is developed as part of the line cards and/or the switch fabric. This, however, has significant disadvantages, and provides limitations as to the line cards and/or switch fabrics that can be used in such a system. The corresponding line card circuitry and switch fabric circuitry thus must include interface circuitry that occupies valuable card space, increases the complexity of line card and switch fabric card design, and reduces the amount of circuit board space available for carrying out the actual data processing and switching functions. This can result in more complex line and switch fabric cards, as well as reduced port densities.

Other existing design limitations also adversely affect the network element efficiencies. Various standards have been devised in order to assist in the development of networking elements such as network routers and switches. One such standard used in networking applications is the Common Switch Interface (CSIX), and more particularly the CSIX-L1 standard which defines an interface between a network processor (e.g., traffic manager) and a switch fabric in data communications applications. Another such standard is the Optical Internetworking Forum (OIF) System Packet Interface-4 (SPI-4) which describes a data path interface between the physical and link layers. Still another standard is the CompactPCI® standard, supported by the Peripheral Component Interconnect (PCI) Industrial Computers Manufacturers Group (PICMG), which is an independent and cooperative consortium of vendors and manufacturers. CompactPCI® (CPCI) is an adaptation of the PCI bus using a more robust mechanical form factor than defined by the PCI specification.

The use of such standards for the purposes in which they are specified facilitates interoperability, as well as facilitating the design of such network elements due to the availability of design information and components to support the standard. Therefore, it is desirable to utilize standards for their specified purpose. However, standards are not created for every situation. In the context of networking design, standards such as the aforementioned CSIX-L1 and OIF-SPI-4 standards are created for a specific purpose, having specific limitations as to their use. These limitations effectively preclude the use of the standards for non-specified purposes.

It would be desirable, however, to utilize an existing standard in designing network elements such as routers and switches, even though the intended use does not perfectly align with the use specified by the standard. It would be desirable to adapt such standards to facilitate more economical and interoperable network element architectures, where circuits such as those housed on line cards and switch fabric cards are more easily added, removed, or replaced as necessary by any of a variety of vendors. A solution to these and other problems identified by the inventors of the present invention is provided herein. The present invention thus fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system and method for interfacing network elements using an isolated fabric interface module, which is facilitated through exploitation of standards otherwise not specified for the particular networking functions in which they are utilized.

A network router is provided in accordance with one embodiment of the invention. The router may be any router, switch, bridge, gateway, or other architecture that switches, routes, or otherwise directs data traversing a network. The router includes line cards having any predetermined type of circuitry, such as line interface and data processing circuitry. The line cards are equipped with line card connectors to facilitate the input and output of signals to and from the line cards. The router also includes switch cards to house switch fabric circuitry, where the switch cards include switch card connectors to facilitate the input and output of signals to and from the switch cards. At least one fabric interface card is provided, where the fabric interface card is physically separate from the line cards and switch cards. The fabric interface card includes fabric interface connectors, and fabric interface circuitry to manage transfers of information between the line cards and the switch cards. A backplane (or midplane) is provided having connectors to receive the line cards, switch cards, and fabric interface card. The backplane serves as a medium to route signal traces that couple the line interface and data processing circuitry on the line cards to the fabric interface circuitry on the fabric interface card, and that couple the fabric interface circuitry on the fabric interface card to the switch fabric circuitry on the switch cards. The isolation of the fabric interface card, and consequently the fabric interface circuitry, from the line and switch cards removes otherwise undesirable dependencies between the line and switch cards.

In accordance with another embodiment of the invention, a method is provided for interfacing circuits in a network routing system. Network line interface circuitry and switch fabric circuitry is located on one or more printed circuit boards (PCB). For example, the network line interface circuitry may be located on one or more line cards, and the switch fabric circuitry may be located on one or more switch cards. A fabric interface circuit which interfaces the network line interface circuitry to the switch fabric circuitry, is separately located on a fabric interface board that is distinct and isolated from the PCBs associated with the network line interface and switch fabric circuits. The PCBs are connected to the fabric interface board, and information is communicated between the network line interface circuitry and the switch fabric circuitry via the distinct fabric interface board.

In accordance with another embodiment of the invention, a method is provided for implementing a standard interface to connect network elements on different circuit boards. The standard interface is governed by a predefined standard otherwise not specified for coupling network elements on different circuit boards connected through a backplane. The predefined standard specifies a maximum interface length which is less than a distance between the network elements. The method includes extending the length of the standard interface beyond the maximum interface length specified by the predefined standard. Signal traces of the standard interface are routed according to predetermined routing rules through circuit board and backplane connectors having impedances substantially corresponding to impedances of the signal traces. The signal traces of the standard interface are terminated proximate the data-receiving network elements. In this manner, the standard interface may be extended beyond the maximum interface length, and may traverse connectors on the various circuit boards.

In more specific embodiments of this method, the network elements on the different circuit boards include a traffic manager and a switch fabric. The predefined standard is the CSIX-L1 standard for interfacing the traffic manager to the switch fabric. The CSIX-L1 standard can thus be used, while effectively allowing the standard to operate at non-specified parameters. In another specific embodiment, the predefined standard is the OIF-SPI-4 standard, and even more particularly the OIF-SPI-4 Phase 1 standard, for interfacing the network elements.

In accordance with another aspect of the invention, a peripheral component interconnect (PCI) interface is implemented in a network router between a CompactPCI® (CPCI)-compliant system controller and line cards that do not fully comply with the CPCI standard. A system slot is provided in a modular chassis that houses the network router. The system slot includes backplane system slot connectors compliant with the CPCI standard to accept the CPCI-compliant system controller. A pinout configuration on matched impedance line card connectors is created to accommodate line card signals, even though these line card connectors and pinout configuration does not comply with the CPCI standard. However, the line card signals include a selected set of signals from the CPCI-compliant system controller, and the selected set of signals from the CPCI-compliant system controller are coupled to the line cards by interconnecting signal traces on the backplane between the backplane system slot connectors and the line card connectors. The line cards can then be controlled from the CPCI-compliant system controller.

In accordance with another embodiment of the invention, a system is provided for interfacing network elements on different circuit boards. The system includes a first circuit board having a first network processor. One or more connectors on the first circuit board are substantially impedance-matched with first circuit board signal traces traversing the connectors from the first network processor. The system includes a second circuit board having a second network processor, where the second circuit board includes connectors substantially impedance-matched with second circuit board signal traces traversing the connectors from the second network processor. A backplane/midplane is arranged to receive and connect the first and second circuit board signal traces, via interface signal traces and connectors that are substantially impedance-matched with the connectors from the first and second circuit boards. An extended-length interface is provided, which is based on a standard interface subject to a predefined standard. The extended-length interface is subject to a set of routing rules not subject to the predefined standard, and has a length greater than a length specified by the predefined standard. The extended-length interface couples the signal traces between the first and second network processors through the interface circuit board, the interface circuit board connectors, and the first and second circuit board connectors. A termination network is coupled to the signal traces proximate the receiving network processor. In this manner, the standard interface is employed to interface network processors on different circuit boards through connectors, although the standard interface is not specified for such use.

In accordance with another embodiment of the invention, a system is provided for implementing a peripheral component interconnect (PCI) interface in a network router. A modular chassis is provided to house the network router, where the modular chassis includes at least one system slot and at least one line card slot. A CompactPCI® (CPCI)-compliant system controller having CPCI-compliant system controller connectors is provided. At least one network line card is provided, having matched impedance line card connectors utilizing a non-CPCI-compliant pinout configuration to accommodate line card signals. The line card signals include a selected set of signals from the CPCI-compliant system controller. A backplane mounted in the chassis includes backplane line card connectors, as well as CPCI-compliant backplane system slot connectors. The backplane line card connectors and backplane system slot connectors can receive the line card connectors and CPCI-compliant system controller connectors at the line card slot and system slot respectively. The backplane couples the selected set of signals from the CPCI-compliant system controller to the line card by interconnecting signal traces between the CPCI-compliant backplane system slot connectors and the line card connectors.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described particular examples of embodiments in accordance with the invention.

### BRIEF DESCRIPTION OF THE DRAWINGS

The invention is described in connection with the embodiments illustrated in the following diagrams.

FIG. 1 is a block diagram illustrating a networking environment in which the principles of the present invention may be applied;

FIG. 2 is a block diagram of an embodiment of a router system in which the present invention may be applied;

FIG. 3 illustrates a exemplary embodiment of a network element, such as a network router or switch, implementing an isolated fabric interface card in accordance with the principles of the present invention;

FIG. 4 is a block diagram illustrating an exemplary manner in which the isolated switch fabric interface circuitry in accordance with the invention may be connected to line cards and switch cards across a midplane;

FIG. 5 illustrates an exemplary embodiment of a CSIX card-to-card architecture in accordance with the principles of the present invention;

FIG. 6 is an embodiment of a more particular CSIX-L1 card-to-card signal interface in accordance with the invention;

FIG. 7 illustrates an exemplary embodiment of an OIF-SPI-4 card-to-card architecture in accordance with the principles of the present invention;

FIG. 8 is an embodiment of a more particular OIF SPI-4 card-to-card interface in accordance with the principles of the present invention;

FIG. 9 is a block diagram illustrating an exemplary embodiment in which the CSIX-L1 and OIF-SPI-4 standard interfaces are extended between multiple cards through connectors in accordance with the invention;

FIG. 10 is a block diagram of an exemplary embodiment of a network switch architecture incorporating both CSIX-L1 and OIF-SPI-4 interface extensions in accordance with the invention;

FIG. 11 is an exemplary embodiment of a network switching module which incorporates the principles of the present invention;

FIG. 12 is a flow diagram of a manner of extending interface lengths for interface standards otherwise not specified for the desired interface lengths;

FIG. 13 is a flow diagram of a more particular embodiment of an extended CSIX-L1 interface in accordance with the invention;

FIG. 14 is a flow diagram of a more particular embodiment of an extended OIF-SPI-4 interface in accordance with the invention;

FIG. 15 illustrates an exemplary embodiment of a manner of implementing a CPCI system controller with high-speed networking peripheral cards;

FIG. 16 shows an exemplary embodiment of a network switching module that incorporates a modified CPCI arrangement in accordance with the invention;

FIG. 17 is a flow diagram illustrating one manner of implementing a PCI interface between a standard CPCI system controller and a network line card in accordance with the invention;

FIG. 18 is a flow diagram illustrating an exemplary method for interfacing circuits in a network routing/switching system; and

FIG. 19 is a flow diagram illustrating a more particular embodiment of a manner of interfacing circuits in a network routing/switching system in accordance with the invention.

### DETAILED DESCRIPTION OF THE INVENTION

In the following description of the exemplary embodiment, reference is made to the accompanying drawings which form a part hereof, and in which is shown by way of illustration specific embodiments in which the invention may be practiced. It is to be understood that other embodiments may be utilized, as structural and operational changes may be made without departing from the scope of the present invention.

The present invention provides a manner of designing network switching/routing elements, utilizing fabric interface circuitry isolated from associated line cards and switch fabrics, while employing specially-adapted standards that are otherwise not specified for the particular networking functions in which they are employed. In accordance with the present invention, functions associated with interfacing line cards and switch fabrics are isolated from the line cards and switch fabric cards, and certain standard networking interfaces are adapted to exploit the standard while facilitating interfaces not specified by the standard. Such interfaces are extended beyond their specified or prescribed lengths, and allowed to be passed between cards through connectors. The standards are utilized to the extent that design complexities and custom design efforts are significantly reduced, yet the invention enables use of the standards in an otherwise non-specified manner. A manner of implementing off-the-shelf computing elements, such as a switch/router system controller, may also be implemented in accordance with the invention. Design modifications are made to accommodate the use of such elements in a manner otherwise not specified by the standard. As a result, a highly efficient, interoperable, network switch or router is provided, which is capable of interoperability with various different switch fabrics and line cards, while allowing the line cards and switch fabrics to be designed pursuant to known standards.

Data transmitted over networks such as the Internet 10 may be in the form of e-mail messages, file transfers and downloads, web page loading, and the like. The data is generally broken up into a number of data packets, frames, or cells, each of which is assigned a hierarchy of headers to direct the data packet to the desired destination, among other things. Each packet is separately dispatched to the destination, although more than one different route may be taken by the various packets associated with the data.

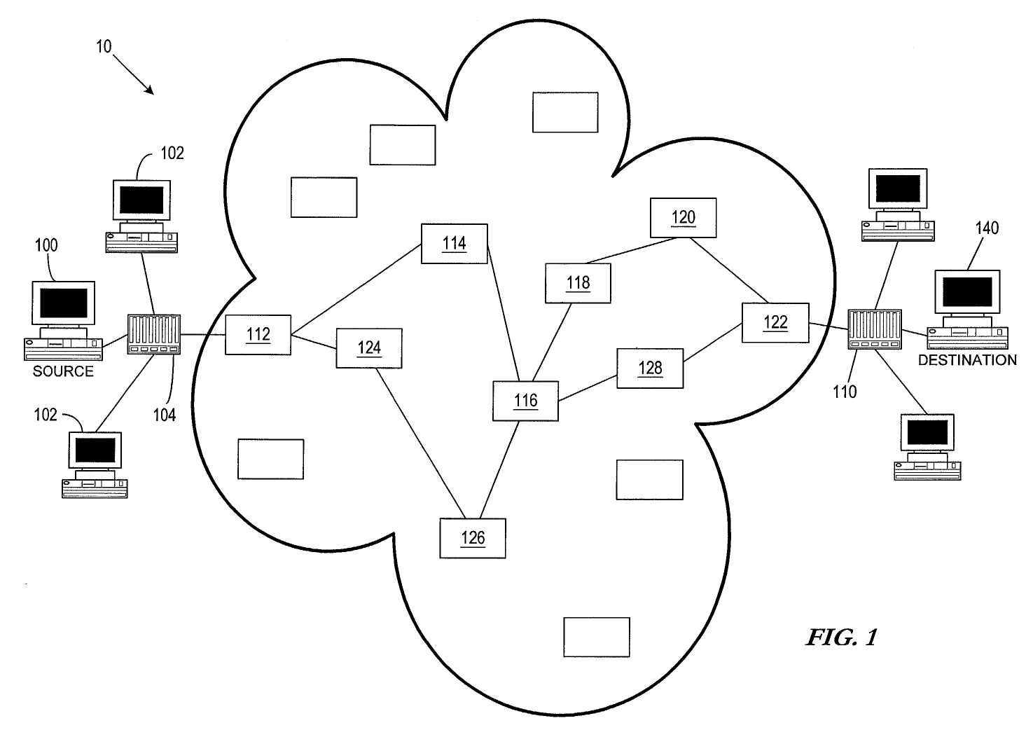

For example, the source computer 100 of FIG. 1 may be configured in a local area network (LAN) and coupled to other computers 102 via a hub 104. A first one or more data packets may reach the hub 110 of the destination LAN via a first path, through routers 112, 114, 116, 118, 120, and 122. A second one or more data packets may reach the hub 110 via a second path, such as through routers 112, 124, 126, 116, 128, and 122. These different packets may take alternative routes due to equipment congestion or failure of a node, to load share where possible, or for other reasons.

In order to direct the network traffic, switches, routers, gateways, bridges, or other traffic directing devices are implemented. The routers associated with the core of the Internet can reconfigure the paths that these packets follow. This is due to the router's ability to analyze the header information corresponding to the data packet and to communicate line condition and other information between routers. The routers handling data at the major traffic points on large networks, such as the Internet, are generally large stand-alone systems. After transmitting the data from node to node through the network, the packets are reassembled at the receiving end and availed to the desired destination system 140.

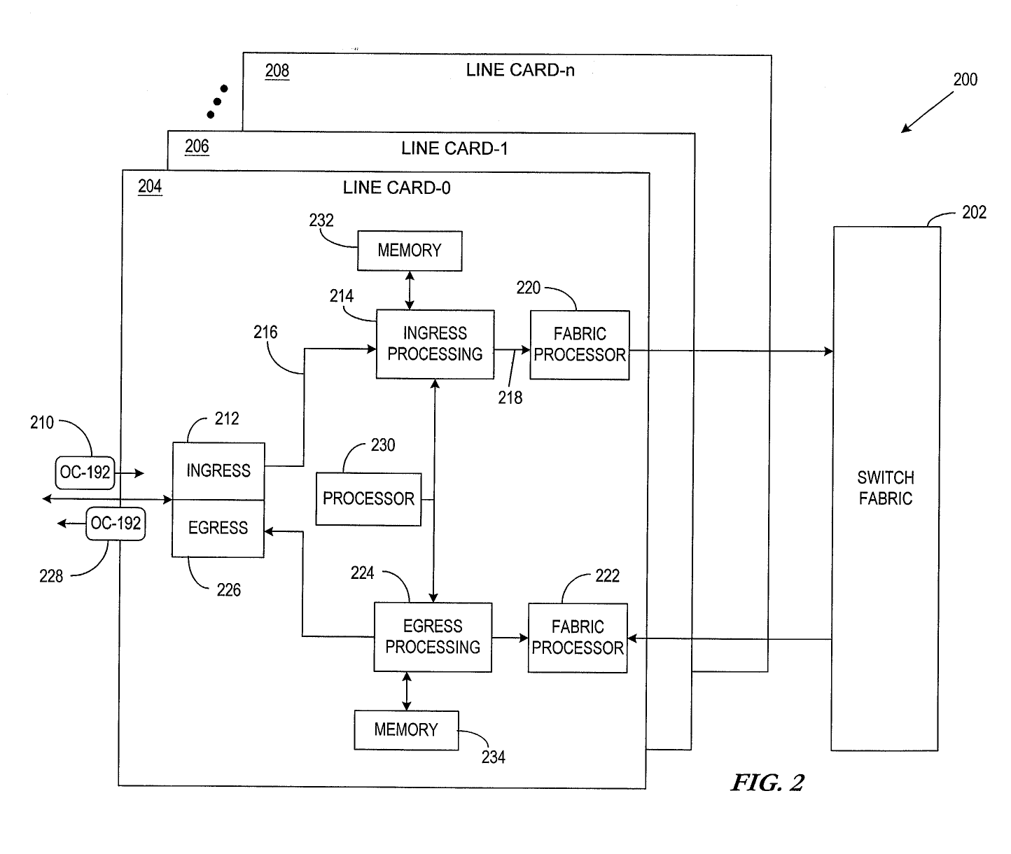

Referring now to FIG. 2, one embodiment of a switching/router system 200 is illustrated in which the present invention may be applied. One or more line cards are provided, each of which are coupled to a switch matrix or switch fabric 202. Generally, a switch fabric provides a manner of transmitting data packets between any one of a plurality of inputs to any one of a plurality of outputs using a matrix of switch elements. The data packets are routed to the appropriate switch fabric output port based on destination information carried within header information of the packet.

In the present example, a plurality of line cards are provided, including line card-0 204, line card-1 206 through a finite number of line cards represented by line card-n 208. Generally, a line card represents any input/output card that can be inserted in a modular chassis. In the context of network routing and switching functionality, the line cards generally include the physical layer components necessary to interface the external data link to the switch fabric. For example, FIG. 2 illustrates a number of line cards which are representative of line cards in which the principles of the present invention are applicable. Certain line card functions are described below for a particular line card in which the principles of the present invention apply, with the understanding that other line cards in the system may implement analogous or non-analogous circuitry.

The line card-0 204 may receive as input Packet-Over-SONET/SDH (POS) frames via the network. As is known in the art, SONET/SDH is a high-speed time division multiplexing (TDM) physical-layer transport technology. POS provides a means for using the speed and management capabilities of SONET/SDH to optimize data transport, although originally optimized for voice. POS allows core routers to send native IP packets directly over SONET/SDH frames. POS provides a relatively low packet overhead and cost per Mbit compared to other data transport methods, which allows POS to efficiently support increases in IP traffic over existing and new fiber networks.

As shown in the exemplary embodiment of FIG. 2, incoming POS OC-192 frames 210 originate from another OC-192 device (not shown) and arrive at the line card-0 204 at the ingress framer 212. The frames are transferred to the ingress processing circuit 214 via an interface 216, such as the Optical Internetworking Forum (OIF) System Packet lnterface-4 (SPI-4). OIF SPI-4 Phase 1 describes a data path interface between the physical and link layers to support physical line data rates up to 10 Gb/s, and may be used in connection with the present invention, as may other interfaces of appropriate speed.

Ingress processing circuit 214 performs the necessary lookups, policing, and editing of the packet. If necessary, the frame can be redirected to the host processor 230. The frames are fed out of the ingress processing circuit 214 via, for example, an OIF SPI-4 interface 218 to an interface device 220 to the switch fabric 202. Generally, the fabric processor 220 converts the data stream from one format to another, such as from POS frames to Common Switch Interface (CSIX) cells, and distributes the cells over the switch fabric 202. However, one aspect of the invention implements a fabric interface that is isolated from the line cards and switch cards. This removes this interfacing function from the line cards such that fabric processor circuits 220, 222 are not resident on the line cards 204, 206, 208 as shown in FIG. 2, but rather are isolated on an independent printed circuit board(s). This is described more fully below.

Cells switched at the switch fabric 202 may be received at the fabric processor 222 and provided to the egress processing circuit 224. Frames are transferred to the egress framer 226, and output as POS OC-192 frames 228. The host processor 230 may be coupled to the ingress processing circuit 214 and the egress processing circuit 224 to perform a variety of functions, including providing coprocessor support. Memories 232, 234 represent one or more memories associated with the ingress processing module 214 and the egress processing module 224 respectively. Again, in one embodiment, the fabric processor 222 is not housed on the line cards 204, 206, 208, but rather are housed on an independent circuit board separate from the line cards 204, 206, 208 or a circuit board housing the switch fabric 202.

In switch and router applications that implement such processing and switching elements as described above, it is desirable to implement existing standards where possible in an effort to reduce custom design efforts and complexity. While the use of standard interfaces and components facilitates the design and provides some “open system” benefits, standards are not available for many applications, particularly high-bandwidth networking applications such as required by high-density switching and routing systems. It is, however, desirable to maximize the use of existing standards, even if such standards are not specified to the particular desired implementation. As set forth below, the present invention utilizes various standards, facilitating ease of design and use, while adapting the design to implement these standards where they are otherwise not specified for use.

Thus, in accordance with the present invention, standard networking interfaces are extended beyond their specified lengths, and allowed to be passed between cards through connectors. The standard is utilized to the extent that design complexities and custom design efforts are significantly reduced, yet the invention enables use of the standard in an otherwise non-specified manner. A manner of implementing off-the-shelf computing elements, such as a switch/router system controller, may also be implemented in accordance with the invention. Design adaptations are made to accommodate the use of such elements in a manner otherwise not specified by the standard.

Utilizing such adapted standards further facilitates implementation of a system where interface circuitry for interfacing the various network processing and switching circuits is isolated from the line cards and switch fabric cards. This ultimately provides for switching and routing systems capable of interoperability with various different switch fabrics and line cards, while allowing the line cards and switch fabrics to be designed pursuant to known standards.

Thus, in accordance with one embodiment of the invention, line cards and switch fabric(s) are provided without fabric interfacing circuitry. Interfacing between line cards and switch fabric cards is provided via an isolated circuit, independent of the line cards and switch fabric until coupled via a backplane or midplane. This arrangement provides a variety of benefits pertaining to development and bandwidth issues concerning high-speed routing and switching elements.

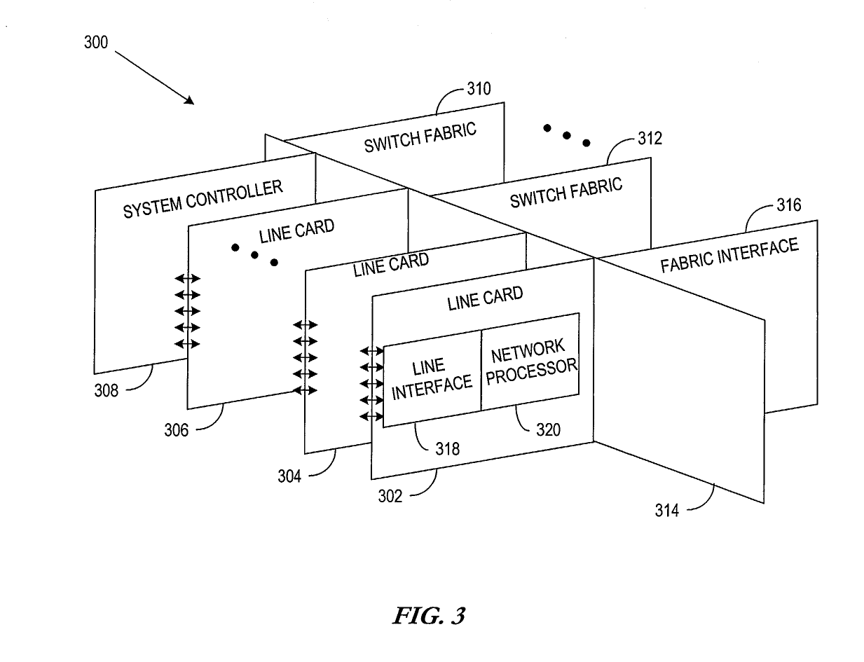

Referring to FIG. 3, various network circuit boards are depicted, as well as a manner of connecting the underlying circuits comprised therein. The example of FIG. 3 illustrates an exemplary network router 300, including one or more line cards 302, 304, 306, one or more system controllers 308, one or more switch fabric cards 310, 312, and a midplane 314 that provides a connection between the circuits on cards 302-312. Also part of the exemplary network router 300 is at least one fabric interface circuit board 316, which independently houses interface circuitry to interface the line cards 302, 304, 306 and the switch fabric 310, 312.

Isolation of the interface circuitry on the fabric interface circuit board 316 provides a variety of benefits. For example, isolating intelligent interface circuitry from the line cards 302, 304, 306 and the switch fabric cards 310, 312 allows for using different, pluggable switch fabrics to be used, without having to change line cards. Alternatively, different pluggable line cards can be used without having to change switch fabrics. This allows for more simple switch fabric and line cards, which can then simply be plugged into the network system 300 (e.g., router, switch, etc.). Pluggable switch fabric cards can be designed to focus on the switching requirements, and line cards can be designed to focus on the network interface.

Segregating interface circuitry from the line cards and switch fabric cards also provides more real estate on these respective cards to handle the tasks that they are intended to provide. For example, by keeping fabric interface circuitry off of the line cards, additional line interface circuitry 318 and network processing circuitry 320 may be employed, advantageously providing a higher port density. In other words, components can be distributed on line cards and switch cards to provide the highest component density on the smallest form factor, which also increases the port densities. Line card and/or switch card complexity is reduced because, for example, line cards do not need to house specific switch fabric interface circuitry.

The isolated fabric interface circuit board 316 is designed as an intelligent interface to manage various types of switch fabrics, line cards, protocols, etc. One such intelligent line-to-switch fabric interface is described in copending U.S. Patent application, Attorney Docket No. 1305.20-US-01, Ser. No. 09/957,751 entitled “Multi-Service Queuing Method And Apparatus That Provides Exhaustive Arbitration, Load Balancing, And Support For Rapid Port Failover”, filed on Sep. 21, 2001, which is assigned to the assignee of the instant application, the contents of which are incorporated herein by reference. Such an exemplary line-to-switch interface provides, among other things, a multi-service switch utilizing virtual input and output queuing with backpressure feedback, redundancy for high availability applications, and packet segmentation and reassembly into variable length cells. Using such an interface, and isolating such an interface in accordance with the invention, routers and switches can provide multiple service classes, efficiently handle multicast traffic, and instantaneously direct the flow of traffic to other ports should there be a failure on a link.

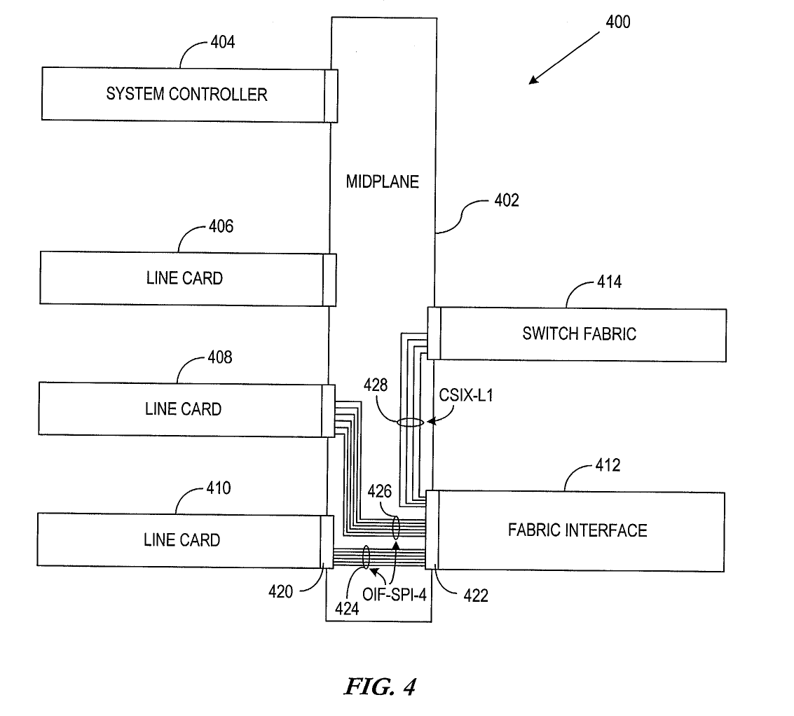

FIG. 4 is a block diagram illustrating an example of how the isolated switch fabric interface circuitry may be connected to the line cards and switch fabric across a midplane in accordance with one embodiment of the invention. In the illustrated embodiment, the network element 400 is a network switch, router, or other network element directing data traffic. The network element 400 includes a midplane 402 allowing circuit boards to be connected from multiple sides, although a connection board coupling the circuit boards from only one side may alternatively be used (e.g., backplane). Coupled to a first side of the midplane 402 are one or more system controllers 404, one or more line cards 406, 408, 410, as well as other circuit boards (not shown). Coupled to a second side of the midplane 402 is at least one switch fabric interface board 412, and at least one switch fabric 414. It should be recognized that alternative embodiments may include a greater or fewer number of circuit boards as depicted in FIG. 4, and some embodiments may not include any of a particular circuit board. For example, one embodiment of the invention could implement system controller features on the line cards such that a separate system controller card(s) 404 is not independently coupled to the midplane 402. Further, the particular location of line cards, switch fabric interface boards, and switch fabric cards may be different from that depicted in FIG. 4, and the particular location and midplane 402 side to which the line cards and switch fabric(s) are coupled are merely representative in the embodiment of FIG. 4.

The exemplary embodiment depicted in FIG. 4 illustrates a manner in which the isolated switch fabric interface board 412 may be coupled to the line cards 406, 408, 410, and switch fabric cards 414 to provide isolated interface functionality in accordance with the invention. As can be seen, the switch fabric interface board 412 is independent of either the line cards 406, 408, 410, or the switch fabric 414. Line cards may be coupled to the switch fabric interface card 412 via the midplane 402. In one embodiment, described more fully below, interfaces complying with predetermined standards are employed to the extent possible, but are modified to allow such standards to be utilized in an otherwise non-specified manner. For example, while an OIF-SPI-4 interface is not specified for coupling line cards to a switch fabric interface on different cards and through connectors, one aspect of the present invention utilizes such a predetermined standard, but adapts the standard for a non-specified interface distance between the line cards 406, 408, 410 and the switch fabric interface 412.

In one embodiment, a line card 410 lined up with the switch fabric interface board 412 through the midplane 402 may be coupled directly by connectors 420, 422, without requiring additional midplane 402 traces therebetween. This may also be referred to as a “pass through” connection. Thus, the OIF-SPI-4 interface 424, as adapted for use in accordance with the present invention, may transmit data between the line card 410 and switch fabric interface 412 via the connector coupling alone in this “pass through” fashion. Alternatively, such an interface may include midplane 402 routing, as depicted in FIG. 4. Another interface between a line card 408 and the switch fabric interface 412 is shown as the OIF-SPI-4 426, which also employs midplane 402 routing traces to couple the line card 408 and the switch fabric interface board 412.

It should be recognized that while the description herein refers to backplane and/or midplane connections using signal traces through such a backplane or midplane, such connections between circuits on two or more circuit boards may alternatively be made in a pass through manner, where the connections are essentially made via the circuit board connectors through the backplane/midplane without requiring additional signal routing on the backplane/midplane. For example, where a midplane is illustrated with circuit boards on either side of the midplane, the connections between circuit boards on opposite sides of the midplane may be made using midplane signal traces between connectors, and/or by way of pass through connections via the circuit board connectors which require no corresponding signal traces on the midplane. Such connections may also be made via cables or other direct connection, without the use of a backplane or midplane. Thus, while aspects of the present invention are described in connection with a backplane/midplane, the invention is clearly not limited thereto.

Interfaces complying with other predetermined standards may also be utilized in accordance with the invention, while being adapted for the particular implementation of the invention. For example, the CSIX-L1 standard is specified for chip-to-chip interfaces up to six to eight inches in length on a single printed circuit board, and does not support longer interfaces or interfaces spanning multiple printed circuit boards through connectors. The CSIX-L1 interface may be used in accordance with the present invention, where the switch fabric interface 412 is isolated from the line cards 406, 408, 410, and the switch fabric 414. This is depicted by the CSIX-L1 interface 428 between the isolated switch fabric interface board 412 and the switch fabric 414.

As described above, the isolation of the switch fabric interface 316 (FIG. 3), 412 (FIG. 4) provides a variety of advantages. Line card and switch fabric manufacturers can develop high-density (and high port-density) cards that can simply be plugged into a network system 400, and the intelligent, isolated switch fabric interface 412 can effectively manage the interface between such circuits. Exemplary manners in which these network circuits may be coupled in accordance with the invention are set forth below, and the realization and benefits of exemplary switch fabric interface circuits may be determined in a manner described herein and in copending U.S. Patent application, Attorney Docket No.1305.20-US-01, Ser. No. 09/957,751 entitled “Multi-Service Queuing Method And Apparatus That Provides Exhaustive Arbitration, Load Balancing, And Support For Rapid Port Failover,” which, as set forth above, has been incorporated herein by reference in its entirety.

As set forth above, standard networking interfaces may be utilized in such a system, although adapted to particular implementations that are otherwise not specified by the standards. Certain standard interfaces may be adapted such that they are extended beyond their specified lengths, and allowed to be passed between cards through connectors. The standard is utilized to the extent that design complexities and custom design efforts are significantly reduced, yet the invention enables use of the standard in an otherwise non-specified manner.

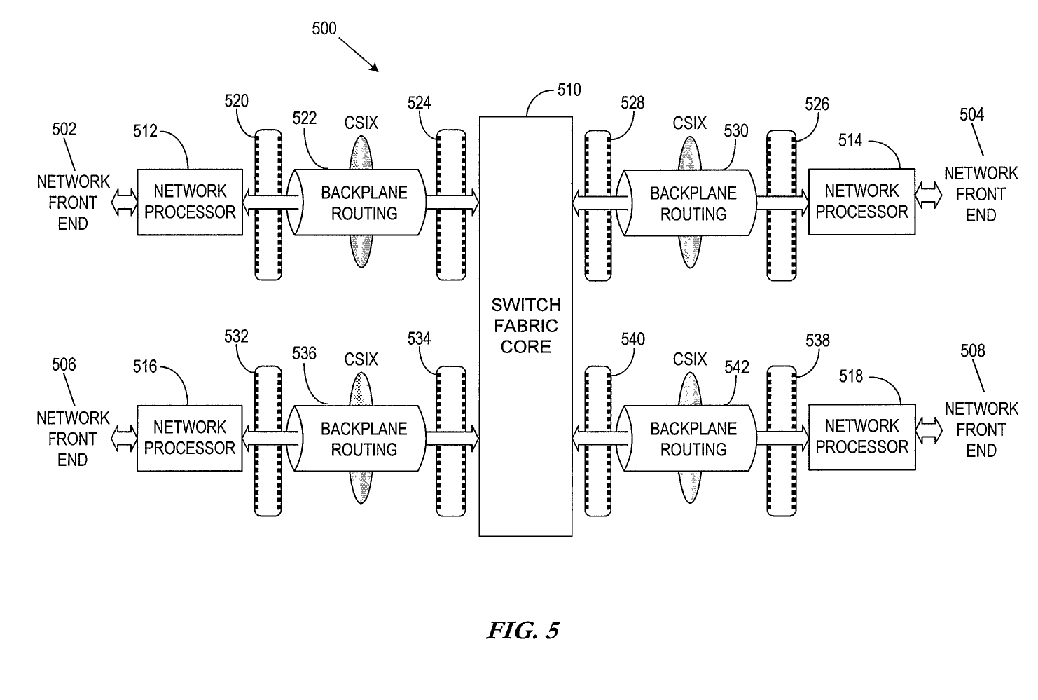

One such standard used in networking applications is the Common Switch Interface (CSIX), and more particularly the CSIX-L1 standard which defines an interface between a network processor (e.g., traffic manager, or any processor used for packetized information) and a switch fabric in data communications applications. The CSIX-L1 standard may be determined in a manner described herein and in the Specification entitled “CSIX-L1: Common Switch Interface Specification-L1,” Version 1.0, dated Aug. 5, 2000, the contents of which are incorporated herein by reference. FIG. 5 illustrates an exemplary embodiment of a CSIX card-to-card architecture 500 in accordance with the principles of the present invention. In this exemplary embodiment, the CSIX standard (more particularly the CSIX-L1 standard) is capable of being utilized over a long-length interface spanning multiple printed circuit boards through connectors. A “long-length” interface as used herein refers to interface lengths exceeding the specified interface length according to the standard. For example, the CSIX-L1 specification defines an interface between a traffic manager and a switch fabric for data communication applications, and specifies certain data formats, signal definitions, and electrical signaling characteristics. However, the CSIX-L1 standard is specifically targeted to chip-to-chip interfaces up to six to eight inches in length on a single printed circuit board, and does not support longer interfaces or interfaces spanning multiple printed circuit boards through connectors.

However, interfaces in high-speed networking cards typically involve implementing very high bandwidth data buses between processing chips. The required interface bandwidth can be much higher than that of the network front-end interfaces to allow for processing and error-correction overhead. Typically, the switch fabric circuits and data processing logic are on separate cards, and interfaces therebetween must pass these high-bandwidth buses through connectors, and often times route the signals over long distances on a backplane, midplane, or other interconnection device or board. One aspect of the present invention allows application of a standard interface such as the CSIX standard over an extended length where the standard is otherwise undesirably limited in length.

In the illustrated embodiment of FIG. 5, data packets arriving via any one of a plurality of network front end circuits 502, 504, 506, 508 may be switched by the switch fabric core 510 such that the data packets are transmitted to any other of the network front end circuits. Generally, a switch fabric provides a manner of transmitting data packets between any one of a plurality of inputs to any one of a plurality of outputs using a matrix of switch elements. The data packets from a network front end, such as network front end 502, may be processed by a network processor 512. The network processors 512, 514, 516, 518 represent any type of network processing module, such as a traffic manager.

Typically, the data packet stream is converted to a particular format, such as converted to comply with the CSIX standard. However, it is generally the case that in order to traverse a backplane or otherwise transmit such data distances longer than that which is supported by the CSIX standard, serializer and deserializer circuits are employed. For example, to traverse a backplane, packets segmented according to CSIX standards generally require conversion between CSIX-L1 data on the traffic manager (network processor) side, and high-speed differential serial data on the switch fabric side. An analogous conversion is required to reconvert the data from the switch fabric to be received at another traffic manager.

In accordance with one aspect of the present invention, no such serializer/deserializer circuitry is required. As shown in FIG. 5, the network processor can transmit CSIX data through a connector 520 associated with a circuit board (e.g., line card) on which the network processor 512 resides, through the backplane routing 522, through a connector 524 associated with a card on which the switch fabric core 510 resides, while implementing the CSIX standard through this interface. As can be seen, other network processors 514, 516, 518 may also communicate with the switch fabric core 510 via the CSIX standard without the use of serializers and deserializers. For example, network processor 514 can communicate with the switch fabric core 510 through connectors 526 and 528 and backplane routing 530. Similarly, network processor 516 can communicate with the switch fabric core 510 through connectors 532 and 534 and backplane routing 536, and network processor 518 can communicate with the switch fabric core 510 through connectors 538 and 540 and backplane routing 542. The backplane routing 522, 530, 536, 542 may be routed through a common backplane, or different backplanes. Further, the backplane routing may be replaced with other connections, such as direct cabling, pass through connections, and the like. Any number of network processors may be coupled to the switch fabric core 510 depending on the particular characteristics of the switch fabric core 510, and the coupling of four network processors to the switch fabric core 510 shown in FIG. 5 is provided for illustrative purposes only. Further, it should be recognized that the term “backplane” used herein refers to an interconnecting circuit board, whether an actual backplane, midplane, etc., regardless of the particular positioning of such interconnecting circuit board in the system.

As can be seen from FIG. 5, the CSIX standard may be implemented for each network processor-to-switch fabric interface, without the need for serialization and deserialization to accommodate interface lengths not supported by the CSIX standard. This greatly reduces the number of chips required to implement switch fabric interfaces by eliminating the need for fabric interface chips and serializer/deserializer chips. It also allows for the development of switch fabrics that operate directly on CSIX-L1 format data, eliminating the need for additional conversion chips within the switch fabric. The reduction in chip count can lead to a significant reduction in design complexity, printed circuit board layout and routing density, and overall system development time and cost. An implementation such as that shown in FIG. 5 also eliminates the need for high-speed serial data streams in the switch fabric interface, further reducing design complexity and development time.

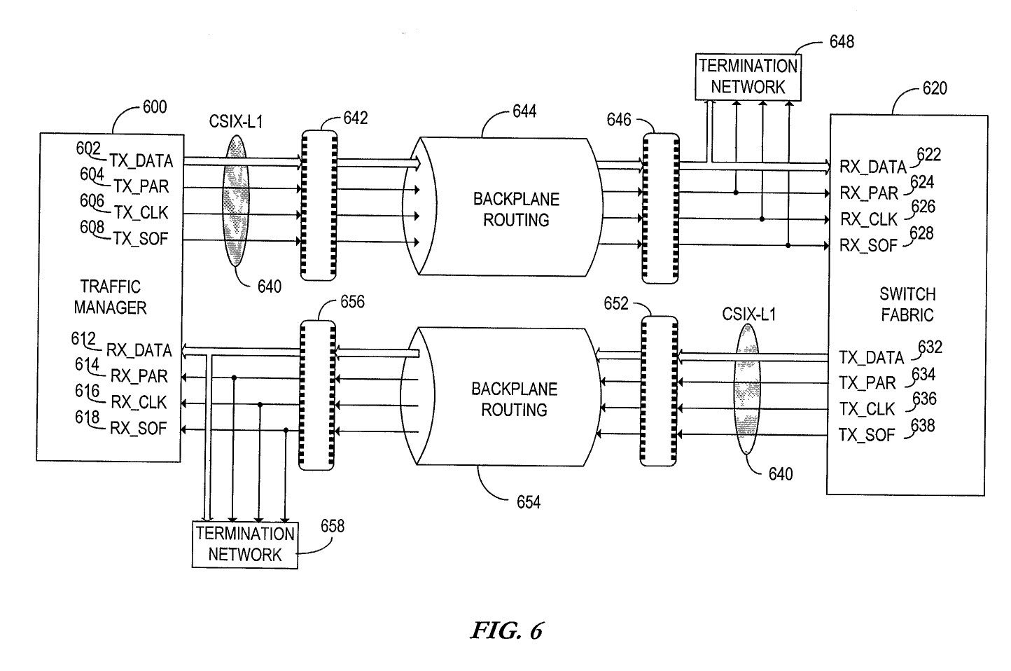

Referring now to FIG. 6, an exemplary embodiment of a particular CSIX-L1 card-to-card signal interface in accordance with the invention is illustrated. In this example, a traffic manager 600 may have data destined for another network processor (not shown). As is known in the art, CSIX-L1 is the Common Switch Interface that defines a physical interface for transferring information between a traffic manager (network processor) and a switching fabric. A CFrame is the base information unit transferred between traffic managers and a CSIX fabric, and includes a header, payload, and a vertical parity trailer. Generally, the CFrame header contains the information required to control the behavior of the interface. The format and values of the CFrame header is what is referred to as CSIX-L1. The payload is a variable-length payload, and is passed by the switch fabric from an ingress traffic manager to an egress traffic manager. The vertical parity trailer is used for error detection at the CSIX-L1 layer. CSIX-L1 utilizes an nx32-bit data path, where n=1, 2, 3, or 4, and the frequency of operation is specified for up to 250 MHz.

Various signals are specified by the CSIX-L1 standard to transfer data, status indications, and control information across the interface. These signals include, and are illustrated on the traffic manager 600 of FIG. 6, transmit data (TX_DATA) 602, transmit parity (TX_PAR) 604, transmit clock (TX_CLK) 606, transmit start-of-frame (TX_SOF) 608, receive data (RX_DATA) 612, receive parity (RX_PAR) 614, receive clock (RX_CLK) 616, and receive start-of-frame (RX_SOF) 618. Similarly, the switch fabric 620 includes signals receive data (RX_DATA) 622, receive parity (RX_PAR) 624, receive clock (RX_CLK) 626, receive start-of-frame (RX_SOF) 628, transmit data (TX_DATA) 632, transmit parity (TX_PAR) 634, transmit clock (TX_CLK) 636, and transmit start-of-frame (TX_SOF) 638. The TX_DATA signals represent one or more data bits, the TX_PAR signals represent one or more data parity bits, the TX_CLK signals represent data transfer/synchronization clock(s), and the TX_SOF signals represent the start of CFrame indicator.

In accordance with the invention, interface signals such as those identified in FIG. 6 may be extended beyond their specified length. For example, the TX_DATA 602, TX_PAR 604, TX_CLK 606, and TX_SOF 608 signals may be provided from the traffic manager 600 to the switch fabric 620 without requiring fabric interface or serializer/deserializer chips, while further allowing for a switch fabric 620 that operates directly on CSIX-L1 format data. These signals 602, 604, 606, 608 are transmitted by the traffic manager 600 using the CSIX-L1 standard 640. The signals may traverse a connector 642 on a circuit board housing the traffic manager 600. From this connector 642, signals may be routed across a backplane, midplane, or other connection board, as represented by the backplane routing 644. The signals may be received at another circuit board housing the switch fabric 620, via another connector 646.

A termination network 648 is coupled to the interface signals, as shown at the RX_DATA 622, RX_PAR 624, RX_CLK 626, and RX_SOF 628 section of the switch fabric 620. The termination network 648 terminates the signals in a manner to minimize signal reflection on the signal paths. The backplane routing 644 is also implemented in a manner to work cooperatively with the termination network and provide a controlled impedance backplane. In accordance with one embodiment of the invention, the connectors 642, 646 are matched impedance connectors, further providing control of signal reflection by approximately matching the connector impedance to the printed circuit board line impedance. Other embodiments may implement connectors that are not necessarily impedance-matched, and/or are otherwise standard connectors, depending on the characteristics of the signals and the particular path in which the signals are transmitted.

Data sent to a traffic manager from the switch fabric 620 operates analogously. For example, the switch fabric 620 may switch data from a network processor (not shown) to the traffic manager 600. CSIX-L1 interface signals from the switch fabric 620 to the traffic manager 600 may also be extended beyond their specified length. For example, the TX_DATA 632, TX_PAR 634, TX_CLK 636, and TX_SOF 638 signals may be provided by the switch fabric 620 to the traffic manager 600 without requiring fabric interface or serializer/deserializer chips. These signals 632, 634, 636, 638 are transmitted by the switch fabric 620 using the CSIX-L1 standard 640. The signals may traverse a connector 652 on a circuit board housing the switch fabric 620. From this connector 652, signals may be routed across a backplane, midplane, or other connection device, as represented by the backplane routing 654. The signals may be received at another circuit board housing the traffic manager 600, via another connector 656.

A termination network 658 is coupled to the interface signals, as shown at the RX_DATA 612, RX_PAR 614, RX_CLK 616, and RX_SOF 618 section of the traffic manager 600. The termination network 658 terminates the signals to minimize signal reflection on the signal paths. The backplane routing 654 is also implemented in a manner to work cooperatively with the termination network 658 and provide a controlled impedance backplane. In accordance with one embodiment of the invention, the connectors 652, 656 are matched impedance connectors, further providing control of signal reflection by approximately matching the connector impedance to the printed circuit board (PCB) line impedance. However, connectors 652, 656 need not necessarily be matched impedance connectors, depending on the characteristics of the interface, such as length, data transfer speed, etc.

In accordance with the invention, other standard interfaces may also be extended beyond their specified lengths. For example, it may be desirable to utilize a particular standard for interfacing certain printed circuit boards (e.g., line cards), components, modules, etc., even though that particular standard is not specified to the interface distances desired. While the previously described CSIX standard is generally employed to interface traffic managers and a switch fabric, other standards exist to accommodate other component interfaces. It may be highly desirable to utilize such standards in interconnecting networking components that are otherwise not supported by the particular standard. For example, development is generally facilitated when such development conforms to a standard, such that the developer can implement standard logic blocks and off-the-shelf interface circuits, which simplifies designs and provides significant flexibility in selecting components. However, the standard may not be specified for use in certain desired situations, such as where the physical interface between components is longer than what the standard allows. Thus, as was true in the examples set forth above relating to the interface extension of CSIX, other useful standards may be implemented using extended interfaces in accordance with the present invention. As will become more evident below, employing such standards, together with the interface extension principles in accordance with the invention, may allow entire networking systems to be constructed using available standards while employing non-specified interface lengths.

Referring briefly to FIG. 2, frames may be transferred to the ingress processing circuit 214 via an interface 216, such as the Optical Internetworking Forum (OIF) System Packet Interface-4 (SPI-4). OIF SPI-4 describes a data path interface between the physical and link layers to support physical line data rates up to 10 Gb/s. Data formats, signal definitions, and electrical signaling characteristics are specified in the OIF-SPI-4 Specification. The SPI-4 standard specifically assumes a point-to-point connection between the link layer and the physical layer, and is not specified for use as an interface between other components, or as an interface spanning multiple printed circuit boards through connectors. The OIF-SPI-4 standard may be determined in a manner described herein and in the Specification entitled “System Physical Interface Level 4 (SPI-4) Phase 1: A System Interface for Interconnection Between Physical and Link Layer, or Peer-to-Peer Entities Operating at an OC-192 Rate (10 Gb/s),” Document No. OIF-SPI-4-01.0, dated Apr. 4, 2001, the contents of which are incorporated herein by reference.

However, even though not specified for the desired use, implementing an interface pursuant to a standard, such as the OIF-SPI-4 standard, may be beneficial in effecting other interfaces. Interfaces in high-speed networking cards usually involve running very high bandwidth data buses between processing chips. The required interface bandwidth can be much higher than that of the network front-end interfaces to allow for processing and error-correction overhead. The development of high-bandwidth interfaces for custom components, or the use of multiple interfaces in a variety of off-the-shelf components, can greatly increase design complexity and development time. Additional circuitry may also be required to translate between the interfaces of one component and another.

One aspect of the present invention adapts a standard such as the SPI-4 standard interface for use at non-specified points in the data path by using it as an interface between network processors. Through the use of matched impedance connectors, controlled impedance printed circuit board routing rules, and line termination techniques, signal quality can be maintained over long distances and over connectors. The use of a standard interface between data path components can greatly simplify designs by allowing the development and use of standard logic blocks and interface circuits, and allowing widespread flexibility in the choice of components.

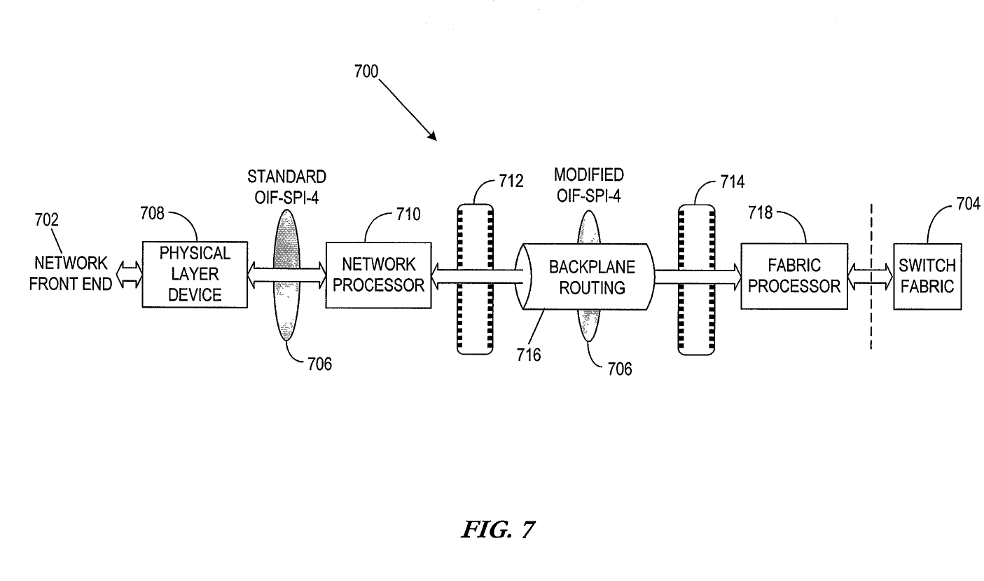

FIG. 7 illustrates an exemplary embodiment of an OIF-SPI-4 card-to-card architecture 700 in accordance with the principles of the present invention. In this exemplary embodiment, the SPI-4 standard is capable of being utilized over a long-length interface spanning multiple printed circuit boards through connectors. For example, while the OIF SPI-4 specification generally defines a point-to-point interface between network processors residing on a common circuit card, the present invention implements the SPI-4 standard across multiple circuit cards.

In the illustrated embodiment of FIG. 7, data packets arriving via any network front end circuit 702 may ultimately be transmitted to a switch fabric 704 for switching. The OIF-SPI-4 standard interface 706 may be applied between components on a common circuit card, such as between a physical layer device 708 (e.g., a framer) and a network processor 710 (e.g., traffic manager). However, the SPI-4 standard is not specified for a long-length interface through connectors. In accordance with the invention, the SPI-4 standard is adapted such that it may also be applied through connectors 712, 714 across a backplane, midplane, or other connection device as represented by the backplane routing 716. Thus, the SPI-4 standard 706 may be applied between a network processor 710 on a first circuit card to a device, such as a fabric processor 718, on a second circuit card. Therefore, in accordance with one aspect of the present invention, the network processor can transmit data through a connector 712 associated with a circuit board (e.g., line card) on which the network processor 710 resides, through the backplane routing 716, through a connector 714 associated with a card on which the fabric processor 718 resides, while implementing the SPI-4 standard through this interface. This greatly enhances the development process, as compared to existing interfaces where the network processor provides a custom data path interface to connect to other network processors or switch fabric. The fabric processor 718 can communicate with the switch fabric 704 through backplane routing and connectors (not shown) implementing the CSIX standard as previously described. For example, the interface between the fabric processor 718 and the switch fabric 704 may be implemented as shown by the interface between the network processor 512 and the switch fabric 510 of FIG. 5.

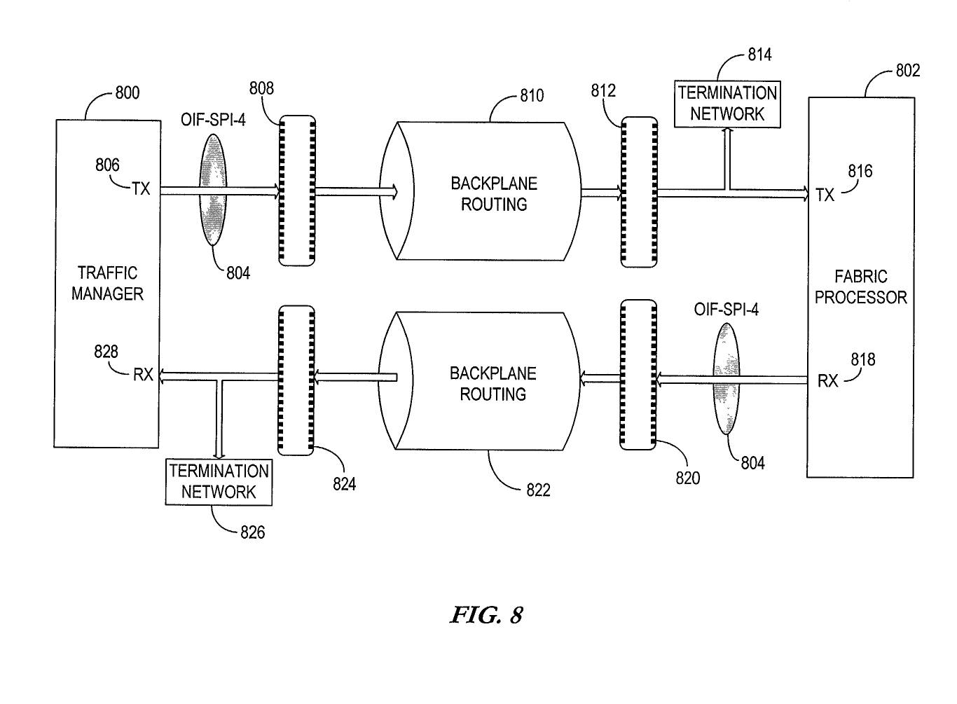

FIG. 8 illustrates an exemplary embodiment of a particular OIF SPI-4 card-to-card interface in accordance with the principles of the present invention. A traffic manager 800 has data destined for another network processor 802. In this example, the network processor 802 is a fabric processor serving to provide an interface between the traffic manager 800 and a switch fabric (not shown). The traffic manager 800 may be housed on a first printed circuit board, such as a line card, and the fabric processor 802 may be housed on a second printed circuit board, such as a circuit card housing fabric interface circuitry in accordance with the invention. The OIF-SPI-4 standard interface 804 may be utilized in accordance with the invention, although the OIF-SPI-4 standard interface is not specified for use over long-length distances through connectors. In accordance with the invention, signals destined for the fabric processor 802 may be transmitted via the transmit (TX) output 806 through the card connector 808, through the backplane routing 810, and through a connector 812.

In order to accomplish this interface extension and signal transmission through connectors, a termination network 814 is used to terminate the interface signals that are received at the receive input (RX) 816. The termination network 814 terminates the signals in a manner to minimize signal reflection on the signal paths. The backplane routing 810 is also implemented in a manner to work cooperatively with the termination network and provide a controlled impedance backplane. In accordance with one embodiment of the invention, the connectors 808, 812 are matched impedance connectors such that the connector impedance approximately matches the printed circuit board line impedance. In other embodiments, connectors 808, 812 may not be matched impedance connectors, depending on the characteristics of the interface, such as length, data transfer speed, etc.

The interface to the traffic manager 800 from transmit (TX) output 818 of the fabric processor 802 (or other network processor) operates analogously and may also implement an extended OIF-SPI-4 interface according to the invention. For example, the fabric processor 802 may direct data to the traffic manager 800 using the SPI-4 standard through connector 820, backplane routing 822, and connector 824 to reach the traffic manager 800.

A termination network 826 is coupled to the interface signals received at the traffic manager 800, as shown at the receive (RX) input 828. The termination network 826 terminates the signals received at the traffic manager 800 to minimize signal reflection on the signal paths. The backplane routing 822 is also implemented in a manner to work cooperatively with the termination network 826 and provide a controlled impedance backplane. In accordance with one embodiment of the invention, the impedance of connectors 820, 824 approximately matches the printed circuit board line impedance, further providing control of signal reflection. In other embodiments, connectors 820, 824 may not be matched impedance connectors, depending on the characteristics of the interface, such as length, data transfer speed, etc.

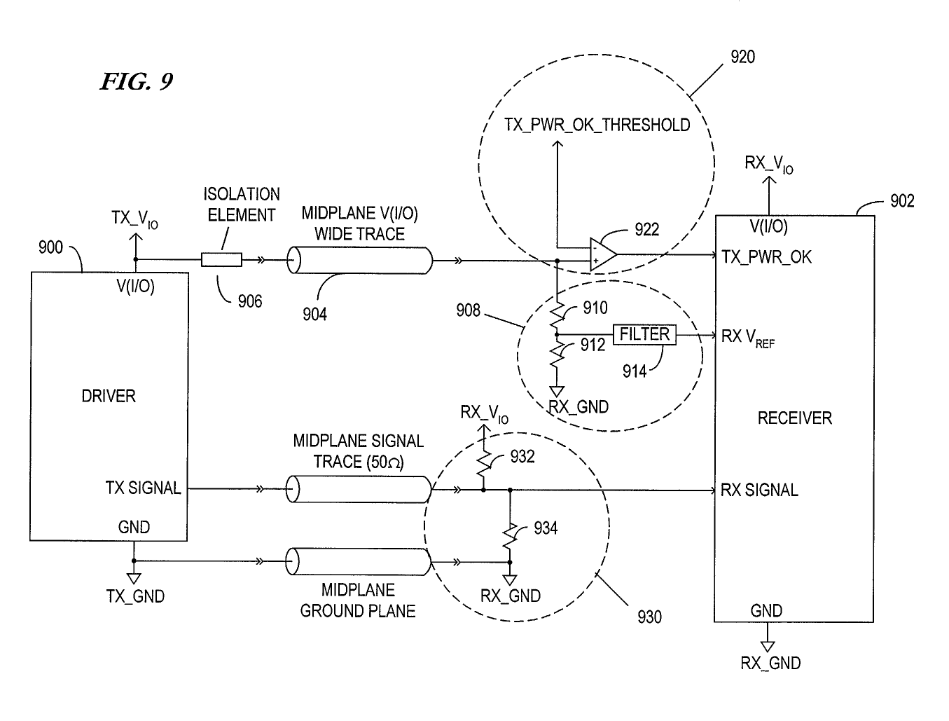

As described above, one aspect of the present invention includes utilizing matched impedance connectors, predetermined routing rules, and a termination network to accomplish standard interface extensions. FIG. 9 is a block diagram illustrating an exemplary embodiment in which the CSIX-L1 and OIF-SPI-4 standard interfaces are extended between multiple cards through connectors in accordance with the invention. It should be recognized that the embodiment of FIG. 9 is representative of the matched impedance connectors, routing rules, voltages, and termination networks that may be implemented in accordance with the invention. Therefore, FIG. 9 merely illustrates a representative embodiment of one manner of carrying out the principles of the invention, although the invention is not limited thereto.

The above description sets forth that the CSIX-L1 and OIF-SPI-4 interfaces may be used between various network elements, such as switches, and network processors including ingress processors, traffic managers, egress processors, fabric processors, and other networking elements. In each instance, the interface is provided between a “driver” and a “receiver.” In FIG. 9, the driver module 900 represents such a network processor, as does the receiver module 902. An exemplary signal interface and line termination on the interface between the driver 900 and receiver 902 is first described.

In an exemplary embodiment of the invention, High Speed Transceiver Logic (HSTL) is used as the signaling technology for the CSIX-L1 and OIF-SPI-4 interfaces. HSTL requires that a reference voltage be supplied at the receiver 902 to set the logic input threshold levels. The reference voltage is typically one half the driver's I/O supply voltage, corresponding to approximately the midpoint of the signal swing. In a chip-to-chip interface on a single circuit board, such as the standard CSIX-L1 and OIF-SPI-4 interfaces, the I/O voltage source of the driver integrated circuit (IC) and the receiver IC will generally be the same. In an interface spanning multiple cards, however, the driver and receiver I/O voltages will be supplied by independent voltage sources. The I/O supply voltage at the receiver 902 may be different than the I/O voltage at the driver 900. Therefore, the reference voltage provided to the receiver 902 should be derived from the driver's 900 I/O voltage supply.

In accordance with the invention, the implementations of the CSIX-L1 and OIF SPI-4 buses over a midplane or backplane add a “driver V_{IO}” signal to the bus. This signal passes the driver's 900 I/O voltage TX_V_{IO} to the receiving card 902, and in one embodiment is routed using a wide, low-impedance trace 904 not subject to the routing rule restrictions applied to data signals. The signal is connected to the driver's V_{IO} supply TX_V_{IO} through an isolation element 906, which in one embodiment is a low value resistor (e.g., 10 ohms) on the driver card 900 in order to provide fault protection. However, the isolation element 906 may be a resistor, fuse, or other component or circuit to provide the desired fault protection. On the receiver card 902, RX_V_{REF} is derived from the TX_V_{IO} signal using a resistor divider 908 including two resistors 910, 912 coupled between the trace 904 and RX_GND in the illustrated embodiment. In one particular embodiment, the resistors 910, 912 are 510 ohm resistors. Other manners of deriving RX_V_{REF} may also be used. Other known manners of dividing the TX_V_{IO} signal may also be employed. The RX_V_{REF} input to the receiver 902 is filtered by filter circuit 914 in order to minimize line noise.

The exemplary interface of FIG. 9 also includes a driver power recognition circuit 920 to manage the situation where the driver 900 is not powered while the receiver 902 is active. In a chip-to-chip interface on a single circuit board, such as the standard CSIX-L1 interface, the driver 900 and receiver 902 will usually be powered by a common voltage source, and will therefore remain powered on at the same time. In an interface spanning multiple cards, the driver 900 and receiver 902 will be powered by independent power sources. The driver 900 or receiver 902 may be turned off, or the driver card or receiver card may be removed from the system, independently. Should the driver 900 be powered off or removed while the receiver 902 is active, the inputs to the receiver 902 will float, possibly causing damage to the receiver IC 902. Therefore, a method is provided to disable the receiver interface in the event that the driver is powered off or removed.

In accordance with the invention, implementations of the CSIX-L1 and OIF-SPI-4 interface buses over a midplane or backplane add a “driver power okay” input to the receiver 902. On the receiver card, the driver V_{IO} (TX_V_{IO}) signal is compared by comparator 922 to a threshold voltage (i.e., TX_PWR_OK_THRESHOLD) to generate the driver power okay signal to provide to the TX_PWR_OK input of the receiver 902. In one embodiment, the threshold voltage is derived from a voltage at the midpoint of a pair of resistances coupled between RX_V_{IO} or RX_Vcc and RX_GND. However, this threshold voltage can be generated in any known manner, including using a separate power source. If the driver V_{IO} level falls below a predetermined threshold, the driver power okay signal becomes inactive, and the receiver IC 902 disables the inputs for that bus. In one embodiment, the receiver 902 inputs are bi-directional HSTL buffers, and when the driver power okay signal becomes inactive, the buffers are switched to output mode and driven to the low state. In one embodiment, the PWR_OK signal is also used to control drivers from the integrated circuit 902 to the integrated circuit 900, such that when the PWR_OK signal is inactive, it causes the driver 900 to go to the low state so as not to drive high logic levels into an otherwise powered-down receiver 902.

To prevent signal reflections on the high-speed data lines, one aspect of the invention utilizes termination networks which are coupled to the CSIX-L1 and OIF SPI-4 buses over a backplane. The termination network, such as the termination 930, adds termination to the receiver end of the bus. In one embodiment, the termination network matches the line impedance (e.g., 50 ohms) and is tied to the mid value of the signal swing (V_{IO}/2). The termination network is located close to the receiver such that it minimizes stub loading. The termination values do not have to be precise, but rather just accurate enough to damp out reflections such that they will not affect signal integrity. Unlike V_{REF}, the receiver's V_{IO} (RX_V_{IO}) may be used to derive the termination voltage.

One exemplary implementation of a termination network 930 uses a dual Thevenin termination network including a low resistance pull-up resistor 932 (e.g., 136 ohms in one particular embodiment) to RX_V_{IO}, and a like-resistance pull-down resistor 934. This exemplary termination is equivalent to 68 ohms to V_{IO}/2. The termination network 930 is positioned proximate the receiver pin (RX SIGNAL), and in one specific embodiment, the termination components 932, 934 are positioned within approximately two inches of the receiver pin RX SIGNAL. The particular termination network 930 utilizing termination resistances 932, 934 is an example of one particular termination network in accordance with the invention, however a variety of other termination networks may alternatively be used.

As was previously described, the connectors through which the interface signals are transmitted are matched impedance connectors in accordance with one embodiment. To maintain signal quality through the connectors, the connector impedance is matched to the printed circuit board (PCB) line impedance. An impedance mismatch will cause signal reflections to occur at the line-to-connector interfaces. The CSIX-L1 and OIF SPI-4 buses use 50-ohm line impedance, and therefore a connector with a controlled impedance of approximately 50 ohms is used. For example, in one implementation of CSIX-L1 and OIF SPI-4 buses over a backplane/midplane in accordance with the invention, Amp Z-PACK HS3 2.5 mm connectors are used. Other 50-ohm controlled impedance connectors could also be used, including FCI/Berg Micropax, Amp Mictor, Teradyne HDM, and Teradyne VHDM connectors.

To preserve signal integrity on the CSIX-L1 and OIF SPI-4 buses, a PCB line impedance of approximately 50 ohms is maintained. Impedance variations or mismatches will tend to cause disruptions in signal quality. Vias increase capacitive loading on the line and can also cause impedance mismatches. Therefore, the number of vias in the signal path is minimized.

An exemplary implementation of CSIX-L1 and OIF SPI-4 buses over a midplane/backplane follow predetermined routing rules in accordance with the invention. For example, in one embodiment the PCB line impedance is maintained at 50 ohms plus or minus approximately ten percent. On the midplane/backplane, where the longest signal runs are typically located, a single-stripline configuration is used, e.g., GND-signal-GND layer stackup. Each line on the midplane/backplane is routed on only one layer, and thus uses no vias in a river routing configuration. Wherever possible, all lines of a bus are routed on the same layer, in order to match trace impedance and propagation delay. All lines of a bus are length-equalized to approximately plus/minus 3.2 millimeters to match propagation delay.

Also in this particular embodiment, on the daughtercards where routing may be more complicated due to signal density, a dual-stripline configuration is allowed, e.g., GND-signalX-signalY-GND stackup. Lines may be routed on multiple layers, but the number of vias is minimized. Further, bus lines are length-equalized to approximately plus/minus 3.2 millimeters to match propagation delay.

The aforementioned represents an exemplary embodiment of the connectors, termination networks, routing rules, voltages, etc. that is applicable for implementation of the extended interfaces in accordance with the invention. As those skilled in the art will readily appreciate from the description herein, other components, component values, configurations, etc. may alternatively be used in connection with the invention. Therefore, the foregoing examples are intended to facilitate an understanding of an implementation of the invention, but the invention is not limited thereto.

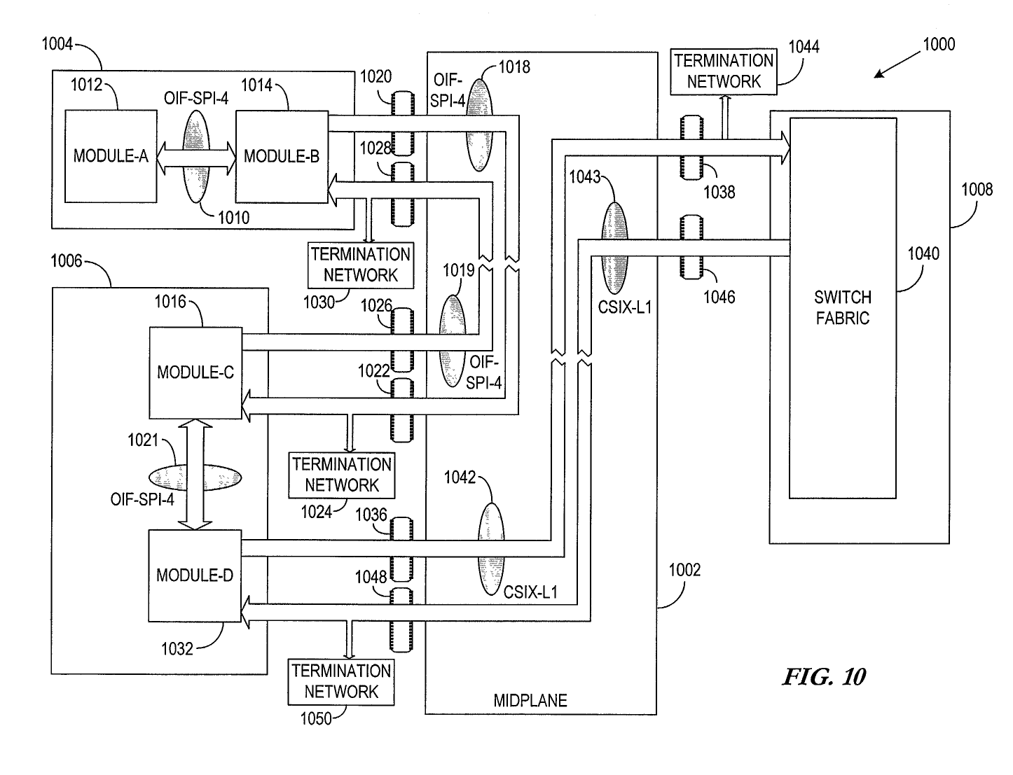

FIG. 10 is a block diagram of an exemplary embodiment of a network switch architecture 1000 incorporating both CSIX-L1 and OIF-SPI-4 interface extensions in accordance with the invention. A midplane 1002 is housed in a modular chassis (not shown). The chassis is adapted to receive a plurality of circuit cards, such as line card 1004, switch fabric interface card 1006, and switch card 1008, where one or more of the circuit cards can be interconnected via the midplane 1002.

Line card 1004 may include a plurality of components, chips, modules, and the like that may utilize a standard interface, such as the OIF-SPI-4 interface 1010. In the illustrated example, two such modules, labeled module-A 1012 and module-B 1014, utilize an OIF-SPI-4 1010 interface in a manner specified by the OIF-SPI-4 specification. In other words, the OIF-SPI-4 standard interface may be utilized between module-A 1012 and module-B 1014 as a point-to-point connection between the link layer and the physical layer.

In accordance with the invention, module-B 1014 associated with line card 1004 may then be connected to module-C 1016 which is housed on circuit card 1006 which provides fabric interface circuitry. Data is transmitted from module-B 1014 to module-C 1016 utilizing an OIF-SPI-4 interface 1018 adapted for use across circuit cards 1004, 1006 via connectors 1020 and 1022. The length of the OIF-SPI-4 interface 1010 between modules B 1014 and C 1016 is extended in accordance with the invention, utilizing matched impedance connectors 1020, 1022, termination network 1024, and midplane 1002 routing rules adapted to minimize signal reflection and ringing. In one embodiment, termination network 1024 is housed on the circuit card 1006.

Analogously, data may be transmitted from module-C 1016 to module-B 1014 utilizing an OIF-SPI-4 interface 1019 adapted for use across circuit cards 1006, 1004 via connectors 1026 and 1028. The length of the OIF-SPI-4 interface 1019 between modules C 1016 and B 1014 is extended in accordance with the invention, utilizing matched impedance connectors 1026, 1028, termination network 1030, and the appropriate routing rules across the midplane 1002. In one embodiment, the termination network 1030 resides on the line card 1004. Thus, the invention allows for the use of the OIF-SPI-4 interface between other components, spanning multiple printed circuit boards through connectors.

Data transmitted from circuit card 1004 to circuit card 1006 may be further transmitted to other modules on circuit card 1006, such as module-D 1032. The interface between modules C 1016 and D 1032 may employ the OIF-SPI-4 interface 1021 in a manner as specified in the OIF-SPI-4 specification. In one embodiment of the invention, circuit card 1006 is an isolated switch fabric interface card having fabric interface circuitry to interface line cards (e.g., circuit card 1004) and switch cards (e.g., circuit card 1008). In such an embodiment, module-C 1016 and module-D 1032 may be combined into a single fabric interface unit such that the OIF-SPI-4 interface 1021 is not required as illustrated. For purposes of discussion, module-C 1016 and module-D 1032 will be discussed as separate processing modules, but it should be recognized that these functional modules can be packaged into a single unit.

Module-D 1032 may comprise a network processor, such as a traffic manager, in which data is to be communicated with a switch fabric 1040 housed on one or more switch cards 1008. The CSIX-L1 specification defines an interface between a traffic manager and a switch fabric for data communication applications, and is therefore desirable for use as an interface between module-D 1032 and the switch fabric 1040. However, the CSIX-L1 is not specified for long-length interfaces spanning multiple printed circuit boards through connectors. In accordance with the present invention, a long-length interface can be implemented. CSIX-L1 data can be transmitted from module-D 1032 through matched impedance connectors 1036, 1038 using the CSIX-L1 interface 1042 adapted for long-length use between multiple circuit cards. Routing rules are applied to the traces routed on the midplane 1002 circuit board in order to minimize signal reflection and ringing. A termination network 1044 is coupled to the data bus and selected control signals proximate the switch fabric 1040. In one embodiment of the invention, the termination network 1044 resides on switch card 1008.

Analogously, CSIX-L1 data can be transmitted from the switch fabric 1040 to module-D 1032. The data transmitted to module-D 1032 may be data switched by the switch fabric 1040 from another line card that has data destined for an output network port on line card 1004. In one embodiment, the interface is managed by a switch fabric interface card 1006. Again, a CSIX-L1 interface 1043 adapted for extended length connections across multiple cards is utilized in transmitting the information. In order to extend the CSIX-L1 interface in accordance with one embodiment of the invention, the information is transmitted through matched impedance connectors 1046, 1048 associated with circuit cards 1008, 1006 respectively, and ultimately back to circuit card 1004. Again, routing rules are applied to the traces routed on the midplane circuit board 1002 in order to minimize signal reflection and ringing, and a termination network 1050 is coupled to the data bus and selected control signals proximate module-D 1032. In one embodiment of the invention, the termination network 1050 resides on circuit card 1006.

As can be seen from FIG. 10, the OIF-SPI-4 and CSIX-L1 standards may be employed throughout the network switch architecture 1000, without the need for serialization/deserialization circuitry and interface translations, while reducing chip counts and design complexities.

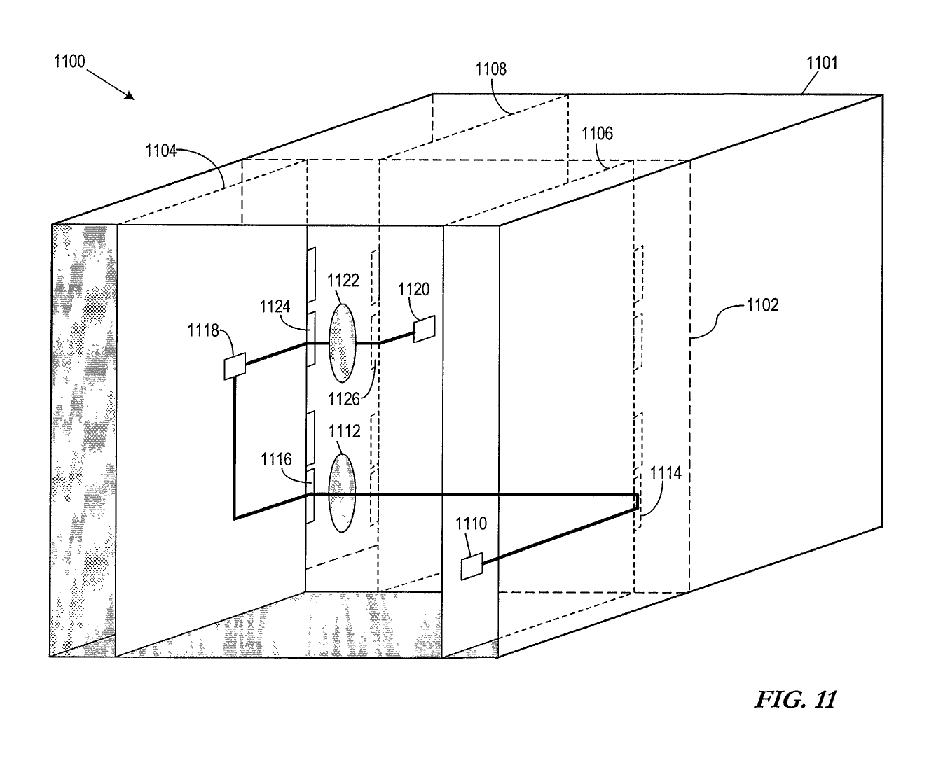

Referring now to FIG. 11, an exemplary embodiment of a network switching module 1100 is illustrated which incorporates the principles of the present invention. Although the switching module 1100 may be a network switch, router, bridge, or other data routing unit, it will be described in terms of a network switch in this particular illustrated embodiment. The switch 1100 includes a modular chassis 1101 for housing network line cards in the switch or router. A midplane 1102 is provided to facilitate the interconnection of circuit cards 1104, 1106, and 1108. In the illustrated embodiment, the circuit cards 1104, 1106, and 1108 represent at least one line card, switch fabric interface card, and switch card. More particularly, circuit card 1108 may represent at least one line card, circuit card 1104 may represent at least one switch fabric interface card, and circuit card 1106 may represent at least one switch card. Each of the circuit cards 1104, 1106 and 1108 includes connectors that plug into connectors on the midplane 1102.

The switch 1100 of FIG. 11 is advantageously connected using both the CSIX-L1 and OIF-SPI-4 standard interfaces, even though the CSIX-L1 and OIF-SPI-4 interfaces are extended beyond their specified lengths and used in otherwise non-specified manners. This allows for standard interfaces to be employed, and allows the switch 1100 to be pre-constructed with an operable midplane 1102 (or backplane). Thus, the switch 1100 may be constructed simply by adding the appropriate line card(s) 1108, fabric interface card(s) 1104, and switch card(s) 1106. This allows a designer to simply add cards subject to the CSIX-L1 and OIF-SPI-4 standards without the need to design a card-to-card interface across the mid plane/backplane.

The midplane 1102 can therefore be pre-constructed implementing predefined routing rules, termination networks can be added to the line and switch cards, and matched impedance connectors (in some embodiments) to allow the CSIX-L1 and OIF-SPI-4 standard interfaces to be implemented. A network processor 1120 on line card 1108 may transmit data pursuant to the OIF-SPI-4 standard interface 1122 through connector 1126, across the midplane 1102, through connector 1124 on fabric interface card 1104, to ultimately reach a fabric processor 1118. Connectors 1126 and 1124 are matched impedance connectors in accordance with one embodiment of the invention. Fabric processor 1118 may in turn direct data to a switch fabric 1110 on switch card 1106, utilizing the CSIX-L1 interface 1112 through matched impedance connectors 1116, 1114 on cards 1104, 1106 respectively.

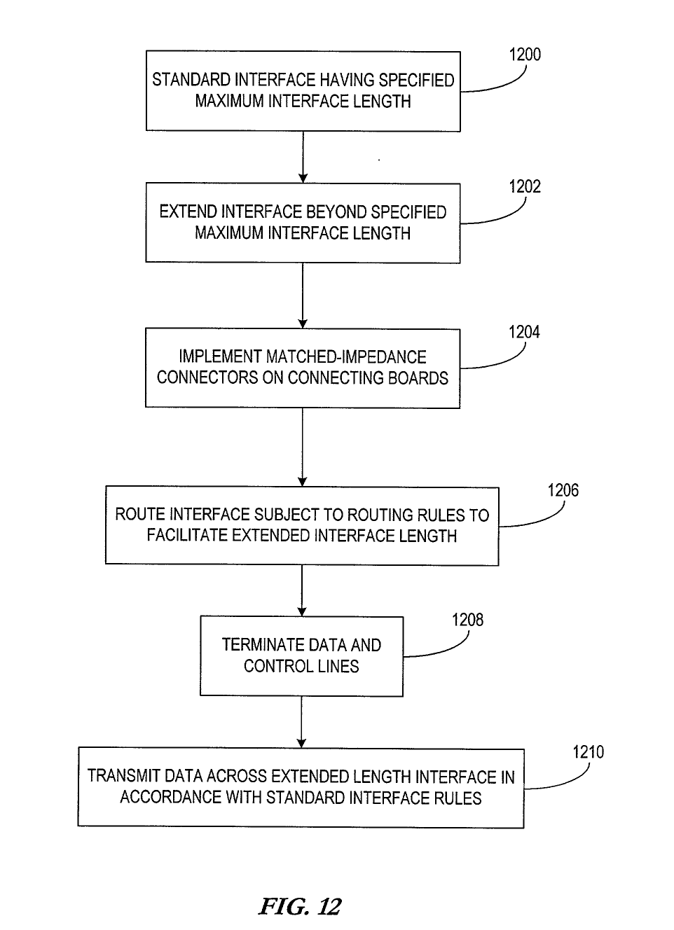

FIG. 12 is a flow diagram of a manner of extending interface lengths for interface standards otherwise not specified for the desired interface lengths. In accordance with the invention, a standard interface may be implemented although the interface length is extended beyond the specified lengths and the interface may traverse multiple cards through connectors. For example, a standard interface may have a maximum prescribed interface length, and/or may not be specified for intercard coupling through connectors, as shown at block 1200. In accordance with the invention, the interface is extended 1202 beyond the specified maximum interface length. Matched impedance connectors are implemented 1204 on the connecting boards such that the impedance of the connectors are approximately matched to the line impedance of the connecting boards. The interface is routed 1206 subject to routing rules to facilitate the extended interface length, and the data/control lines are appropriately terminated 1208. The data is transmitted 1210 across extended length interfaces, through connectors on multiple circuit boards, and potentially including a midplane/backplane or other interconnect board, while otherwise employing the standard interface rules.

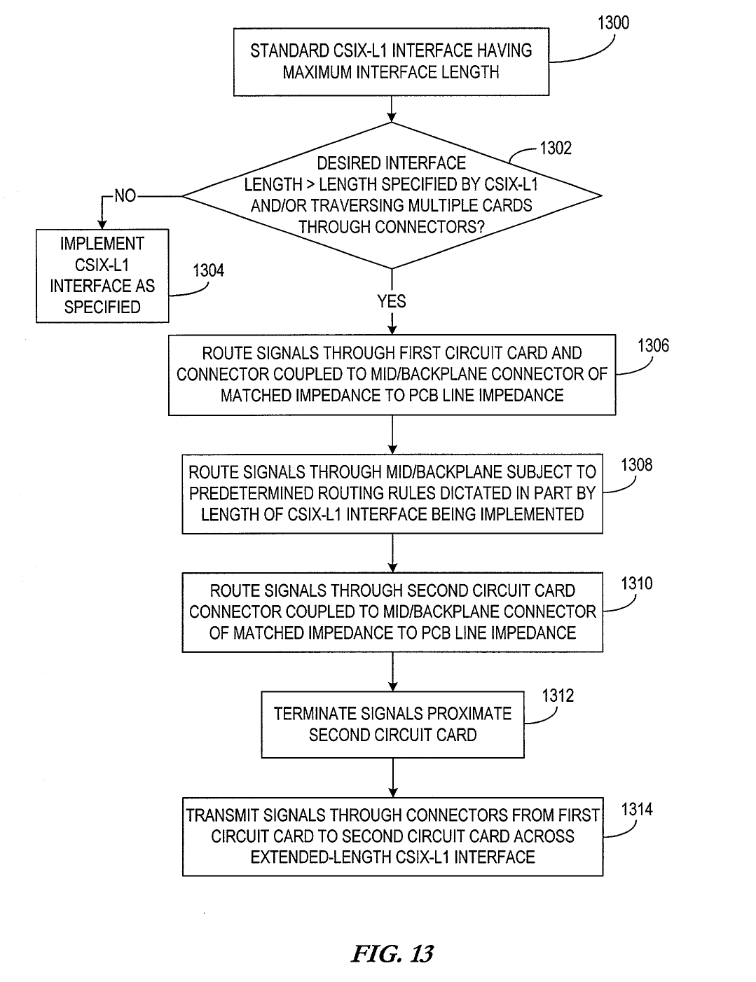

FIG. 13 is a flow diagram of a more particular embodiment of an extended CSIX-L1 interface in accordance with the invention. In accordance with the invention, a standard CSIX-L1 interface may be implemented although the interface length is extended beyond the specified lengths and the interface may traverse multiple cards through connectors. For example, a CSIX-L1 interface has a targeted maximum interface length, and is not specified for intercard coupling through connectors, as shown at block 1300. If the desired interface length is not greater than that specified by the CSIX-L1 Specification and the desired interface does not traverse multiple cards through connectors as determined at decision block 1302, the standard CSIX-L1 interface may be implemented 1304 as specified.

If the desired interface length is greater than that specified by the CSIX-L1 Specification and/or the desired interface traverses multiple cards through connectors as determined at decision block 1302, signals are routed 1306 through the first circuit card, such as a fabric interface card, and associated connector coupled to the mid/backplane connector of matched impedance to the printed circuit board line impedance. The signals are routed 1308 through the mid/backplane subject to predetermined routing rules dictated in part by the length of the CSIX-L1 interface being implemented. The signals are further routed 1310 through a second circuit card, such as a switch card, and associated connectors coupled to the mid/backplane connector of matched impedance, and terminated 1312 proximate a second circuit card such as the switch card. The signals can thus be transmitted 1314 through the connectors from the first circuit card (e.g., line card) to the second circuit card (e.g., switch card) across the extended-length CSIX-L1 interface.

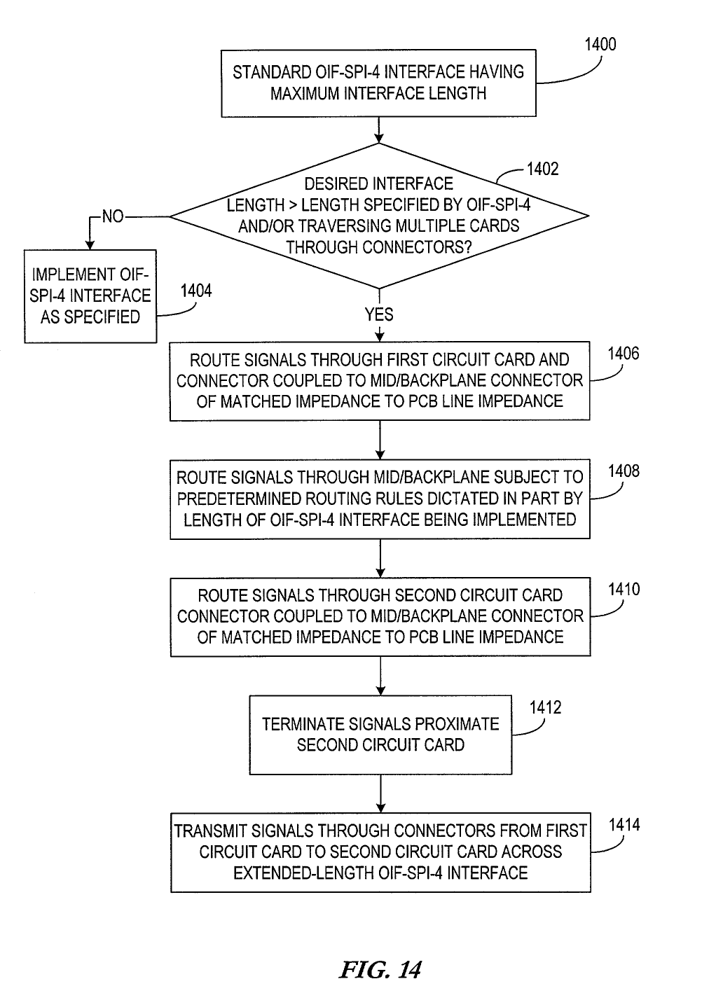

FIG. 14 is a flow diagram of a more particular embodiment of an extended OIF-SPI-4 interface in accordance with the invention. In accordance with the invention, a standard OIF-SPI-4 interface may be implemented although the interface length is extended beyond the specified lengths and the interface may traverse multiple cards through connectors. For example, a OIF-SPI-4 interface may have a specified maximum interface length, and may not be specified for intercard coupling through connectors, as shown at block 1400. If the desired interface length is not greater than that specified by the OIF-SPI-4 Specification and the desired interface does not traverse multiple cards through connectors as determined at decision block 1402, the standard OIF-SPI-4 interface may be implemented 1404 as specified.

If the desired interface length is greater than that specified by the OIF-SPI-4 Specification and/or the desired interface traverses multiple cards through connectors as determined at decision block 1402, signals are routed 1406 through a first circuit card, such as a line card, and associated connector coupled to the mid/backplane connector of matched impedance to the printed circuit board line impedance. The signals are routed 1408 through the mid/backplane subject to predetermined routing rules dictated in part by the length of the OIF-SPI-4 interface being implemented. The signals are further routed 1410 through a second circuit card, such as a fabric interface card in accordance with one embodiment of the invention, via a connector(s) coupled to the mid/backplane connector of matched impedance, and terminated 1412 proximate the second circuit card. The signals can thus be transmitted 1414 through the connectors from the first circuit card to the second circuit card across the extended-length OIF-SPI-4 interface.

Design simplification and cost reduction of high-speed networking systems, such as the switch 1100 of FIG. 11, can be further advanced by employing standards for the control interface. One such standard is the CompactPCI® standard, supported by the Peripheral Component Interconnect (PCI) Industrial Computers Manufacturers Group (PICMG)—an independent and cooperative consortium of vendors and manufacturers. CompactPCI® (CPCI) is an adaptation of the PCI bus using a more robust mechanical form factor than defined by the PCI specification. PCI defines an input/output (I/O) bus that links peripherals to a host bus, where the host bus links the central processor unit and the memory. The CPCI Specification (PICMG 2.0) defines circuit boards based on the 3U and 6U Eurocard form factors per IEC 60297-3 and IEC 60297-4. The system controller and peripheral logic cards plug into a passive backplane using 2 mm-pitch connectors as defined by IEC 60917 and IEC 61076-4-101. Cards are powered by distributed 3.3V, 5V, 12V, and −12V as in a standard desktop computer. Data formats and electrical signaling characteristics are based on the PCI Local Bus Specification. CPCI adds provisions such as system management, hot-swappable cards, and industrial computer mechanical form factors. The CompactPCI® standard may be determined in a manner described herein and in the Specification entitled “CompactPCI® Specification,” PICMG 2.0 R3.0, dated Oct. 1, 1999, the contents of which are incorporated herein by reference.

However, interfaces in high-speed networking systems usually involve high-density, high-speed buses which cannot be implemented in systems designed to the existing CPCI Specification. Such systems may also require more power than allowed by CPCI. The advantages of CPCI, however, are still highly desirable in such network systems. For example, the use of standard PCI-based components, rugged mechanical design, industry standard industrial computer form factor, etc. are all desirable features.

The present invention further provides for the implementation of a PCI interface over the backplane/midplane which couples an off-the-shelf CPCI system controller(s) to peripheral cards which do not precisely follow the CPCI standard. In this manner, standard CPCI system controllers can be used to perform a variety of control and configuration functions in connection with peripheral cards that are not fully CPCI compliant. High-speed networking systems utilize peripheral cards that may require pin counts, supply voltages, or other characteristics that are not supported by the CPCI standard. Therefore, in accordance with the present invention, a switch, router, etc., such as switch 1100 in FIG. 11, may incorporate features unique to such high-speed networking requirements, while implementing a standard CPCI system controller(s).

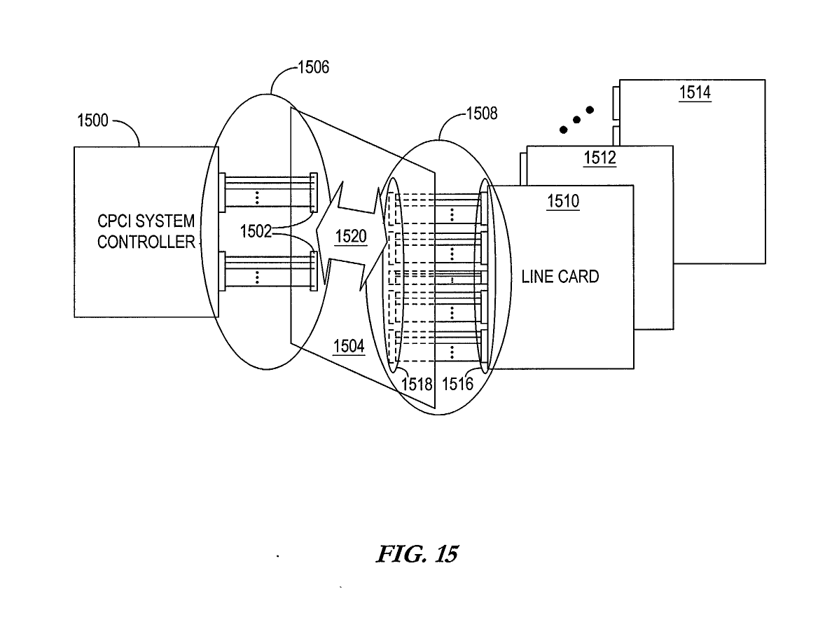

FIG. 15 illustrates an exemplary embodiment of a manner of implementing a CPCI system controller 1500 with high-speed networking peripheral (line) cards. System slot connectors 1502 on the midplane 1504 may be in compliance with the CPCI Specification. Therefore, the CPCI system controller 1500 may connect to the midplane 1504 in a conventional manner, such that the connectors, pin counts, pinout configurations, signals, etc. of the interface 1506 are compliant with CPCI standards.

The interface between the midplane 1504 and the line cards 1510, 1512, 1514 is a modified CPCI interface 1508 in accordance with the invention. The peripheral cards, such as line cards 1510, 1512, 1514, may use non-CPCI compliant connectors 1516, 1518 selected to accommodate the very high speed buses elsewhere in the system. Optional, legacy, and/or unused signals may be removed from the bus 1520 to reduce pin count, thereby availing these pins for additional signaling corresponding to high-speed networking functions and interfaces. In accordance with one embodiment of the invention, the line cards 1510, 1512, 1514 are based on the Eurocard form factor thus allowing use of standard chassis components, but the line card height is increased to 9U to provide more board area. Low voltage power (e.g., 3.3V and 5V) is distributed to each line card to power the PCI bus. In one embodiment, −48V DC power is also distributed to each peripheral card to power the circuitry resident thereon. The use of −48V DC power distribution to each line card 1510, 1512, 1514 allows for the system to meet the high power requirements of high-speed networking cards, and is a standard method of power distribution.

In one embodiment, PCI reset and Intelligent Platform Management Bus (IPMB) signals are not bused, but rather are passed to a secondary system monitoring/control card (not shown), which are in turn driven to each peripheral slot over point-to-point links to allow individual control and isolation of the peripheral cards. This design greatly improves capabilities for fault detection and isolation in the system. In another embodiment of the invention, PCI-to-PCI bridge components are used to increase the allowed length and number of leads of the PCI interface.

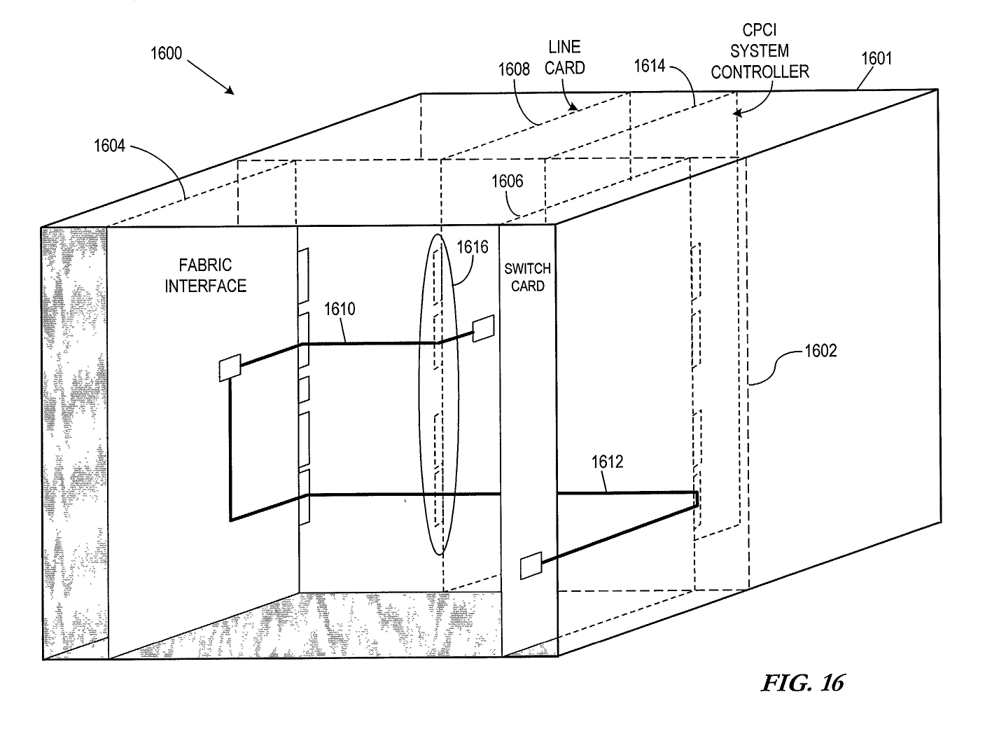

Referring now to FIG. 16, an exemplary embodiment of a network switching module 1600 is illustrated which incorporates a modified CPCI arrangement as described in connection with FIG. 15. The switching module 1600 may be a network switch, router, bridge, or other data routing unit, and includes a modular chassis 1601 for housing network line cards in the switch or router. A midplane 1602 is provided to facilitate the interconnection of line card(s) 1608, fabric interface card(s) 1604, and switch card(s) 1606. Each of the circuit cards 1604, 1606, 1608 includes connectors that plug into connectors on the midplane 1602.

The switch 1600 may employ an extended-length CSIX-L1 interface 1612 between circuit cards such as between switch card(s) 1606 and fabric interface card(s) 1604. An extended-length OIF-SPI-4 interface 1610 may also be employed between fabric interface card(s) 1604 and line card(s) 1608. This allows for standard interfaces to be employed, and allows the switch 1600 to be pre-constructed with an operable midplane 1602 (or backplane).

Further, a standard, off-the-shelf CPCI system controller 1614 may be housed in the chassis 1601 to provide the control interface to the circuit cards 1604, 1606, and/or 1608. As previously described, the signals, connectors, etc. associated with the CPCI system controller 1614 comply with the CPCI Specification. Unused and legacy signals provided by the CPCI system controller 1614 are not passed on the midplane 1602 in one embodiment of the invention, thereby freeing pins on the connectors of the peripheral cards. Signals from the CPCI system controller 1614 are routed through the midplane 1602 to the appropriate pins of connectors 1616, for example, where the connectors 1616 employ a predetermined pin configuration suitable for proper operation and interfacing by the respective peripheral card(s). In accordance with one embodiment of the invention, the pinout configuration of the connectors 1616 does not comply with the CPCI standard. This change is due to additional signals required by the high-speed networking peripheral cards, and by the possible use of non-CPCI compliant connectors. Another reason that the pinout configuration of the connectors 1616 differs from the CPCI Specification is that signals unused by the line card, as well as legacy signals, are not routed over the midplane 1602 from the CPCI system controller 1614 to the line card 1608 (or other peripheral cards). This frees up additional pins on the peripheral card connectors. In one embodiment, the connectors 1616 and the mating connectors (not shown) on the midplane 1602 are matched impedance connectors.

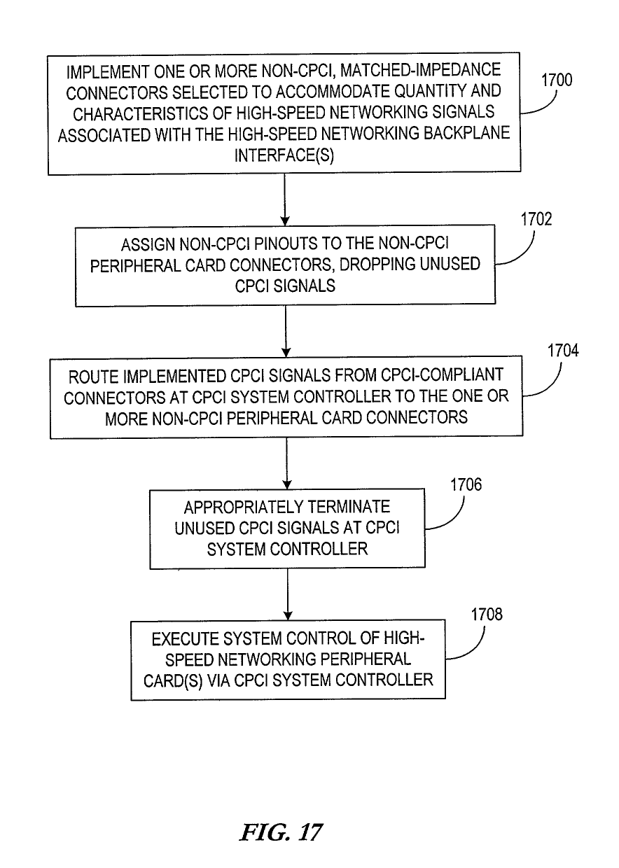

FIG. 17 is a flow diagram illustrating one manner of implementing a PCI interface between a standard CPCI system controller and a non-CPCI compliant peripheral card in accordance with the invention. As shown at block 1700, one or more connectors, which need not be compliant with CPCI, are implemented on the peripheral cards. These connectors are selected to accommodate the pin counts and electrical qualities characteristic of the high-speed networking signals that will be received and transmitted via the peripheral card(s). In one embodiment, these connectors are impedance-matched with the midplane or backplane line impedance.

These potentially non-CPCI connectors may be selected such that more, or less, pins are available than a connector defined by the CPCI standard. For example, in one embodiment of the invention, non-CPCI connectors are selected which include a greater number of pins than the specified CPCI connectors. In this manner, a greater number of signals may be transmitted to and from the peripheral card(s), which is likely in high-speed networking implementations. Non-CPCI pinouts are thus assigned 1702 to the non-CPCI peripheral card connectors, dropping signals from the peripheral card connector pinout specified by the CPCI Specification that are unused at the peripheral cards, such as unused legacy signals. In other words, while a standard CPCI system controller is used which provides the standard CPCI signals at the system controller connector pins, those CPCI signals that are not used by the peripheral cards are not routed on the backplane/midplane. This frees up additional pins on the peripheral card connectors.

The implemented CPCI signals from the CPCI-compliant connectors at the CPCI system controller are routed 1704 to the non-CPCI peripheral card connectors. CPCI signals not implemented on the mid/backplane may be appropriately terminated 1706 at the CPCI system controller connectors on the mid/backplane, if necessary. In the manner described above, system control associated with the high-speed networking peripheral cards may be executed 1708 via an off-the-shelf CPCI system controller. This allows a network switch or router to utilize a standard system controller, thus reducing design effort and complexity.

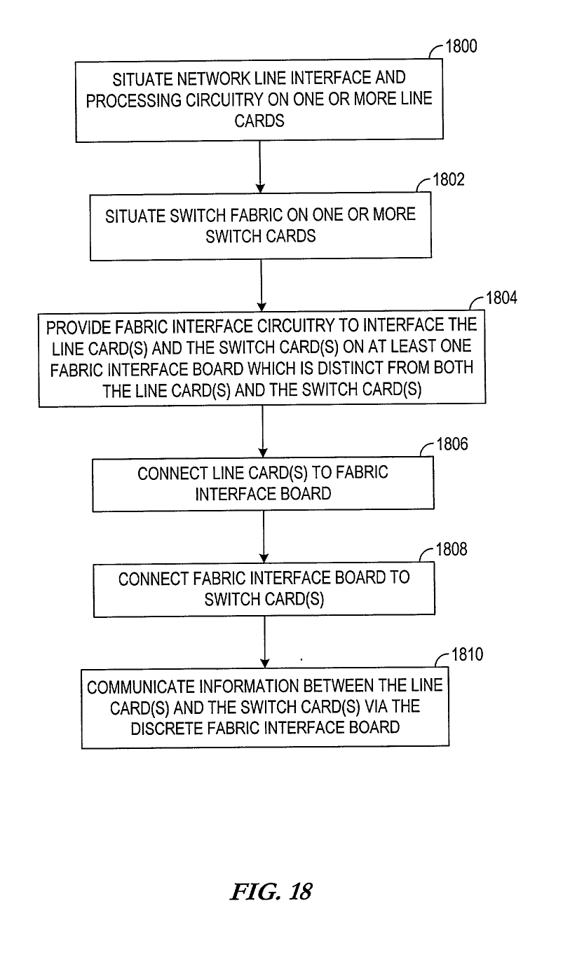

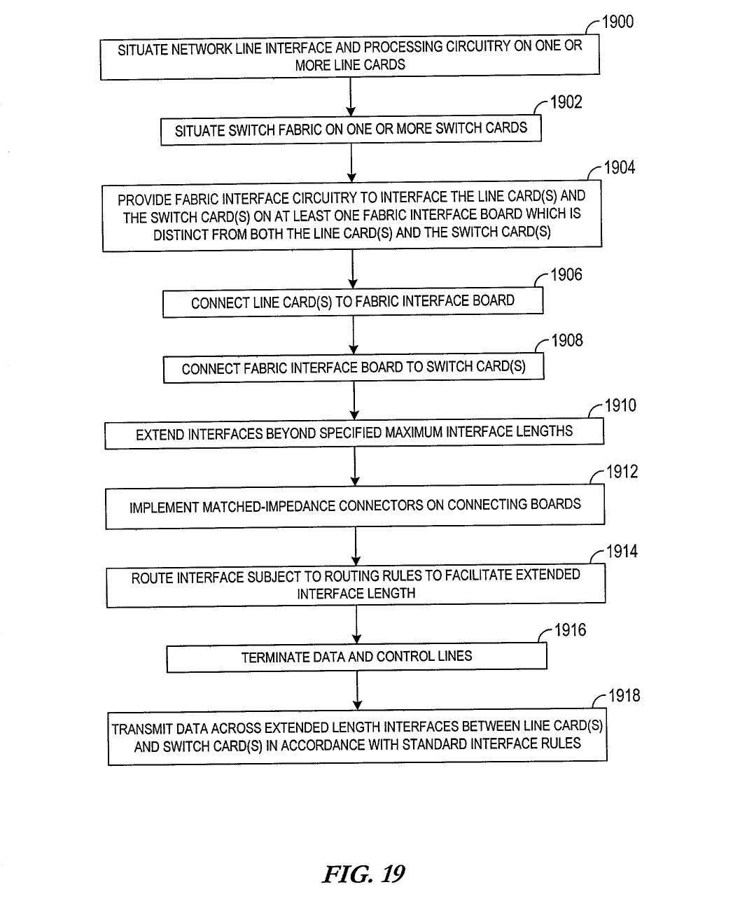

As previously indicated, the use of various standards adapted in the manners described above facilitates implementation of a system where interface circuitry for interfacing the various network processing and switching circuits is isolated from the line cards and switch fabric cards. This ultimately provides for switching and routing systems capable of interoperability with various different switch fabrics and line cards, while allowing the line cards and switch fabrics to be designed pursuant to known standards. FIGS. 18 and 19 illustrate exemplary methods for providing such systems.

FIG. 18 is a flow diagram illustrating an exemplary method for interfacing circuits in a network routing/switching system, and FIG. 19 is a flow diagram illustrating an exemplary implementation of such an interfacing methodology. Referring first to FIG. 18, network line interface circuitry is situated on one or more line cards as shown at block 1800. The network line interface circuitry represents circuitry used in interfacing the incoming and outgoing data with the network switch or router. Further, these line cards may include additional circuitry, such as data processing circuitry, including classification, policing, and editing circuitry. An exemplary line card according to the invention was described in connection with FIG. 2, however in accordance with the present invention, the fabric processor circuitry 220, 222 is eliminated from the line cards 204, 206, 208 (refer to FIG. 2). In accordance with the invention, switch fabrics are located on one or more switch cards, as illustrated at block 1802, and thus no fabric interfacing circuitry need be resident on either the line cards or the switch cards.

As shown at block 1804, one aspect of the invention provides fabric interface circuitry on a fabric interface board that is distinct from both line cards and switch cards in the system. The fabric interface circuitry interfaces the line cards and the switch cards. Examples of such an isolated fabric interface board were previously discussed in connection with FIGS. 3 and 4. The line cards are connected 1806 to the fabric interface board, and the fabric interface board is also connected 1808 to the switch cards. Information can then be communicated between the line cards and the switch cards via the discrete fabric interface board as shown at block 1810. This allows, among other things, different line cards to be used without having to change switch cards, and vice-versa.

FIG. 19 illustrates a more particular embodiment of a manner of interfacing circuits in a network routing/switching system in accordance with the invention. In this embodiment, isolated fabric interface circuitry is utilized as described in connection with FIG. 18, and standard interfaces are adapted to provide the interface between the line cards, the isolated fabric interface board, and the switch cards.

Network line interface circuitry is situated on one or more line cards as shown at block 1900, and switch fabrics are located on one or more switch cards as illustrated at block 1902. As shown at block 1904, the fabric interface circuitry is provided on a fabric interface board that is distinct from both line cards and switch cards in the system. The line cards are connected 1906 to the fabric interface board, and the fabric interface board is also connected 1908 to the switch cards.

As set forth above, one aspect of the invention provides a manner of extending interface lengths for interface standards otherwise not specified for the desired interface lengths. A standard interface may be implemented although the interface length is extended beyond the specified lengths and the interface may traverse multiple cards through connectors. For example, a standard interface may have a specified maximum interface length, and/or may not be specified for intercard coupling through connectors, such as coupling line cards and switch cards through an isolated fabric interface board. In accordance with the illustrated embodiment, interfaces are extended 1910 beyond the specified maximum interface length. For example, CSIX-L1 and OIF-SPI-4 interfaces may be used between the fabric interface board and switch cards, and between the line cards and fabric interface board. Matched impedance connectors are implemented 1912 on the connecting boards such that the impedance of the connectors are approximately matched to the line impedance of the connecting boards. For example, in one embodiment, connectors on the line cards, fabric interface board, switch cards, and backplane/midplane are selected to have impedance characteristics that substantially match the impedance of the signal traces in which they connect. The interface is routed 1914 subject to routing rules to facilitate the extended interface length, and the data/control lines are appropriately terminated 1916. The data is transmitted 1918 across extended length interfaces, through connectors on multiple boards including the isolated fabric interface board, while otherwise employing the standard interface rules.

As can be seen from the foregoing, a high-speed switch/router can be constructed in a single modular chassis, employing various known standards to simplify designs, while accommodating the unique needs of such a high-speed network element. For example, in one embodiment of the invention, the CSIX-L1 standard, the OIF-SPI-4 standard, and the CompactPCI® standard can be more widely implemented in the switch or router, due to the various adaptation and enhancement principles described herein. A network element, such as a router or switch, may thus be implemented in a common chassis, where an isolated fabric interface module is realized implementing the various standards adapted in a manner as set forth herein.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A network system, comprising:
one or more line cards having line interface and data processing circuitry, and line card connectors, coupled thereto;
one or more switch cards having switch fabric circuitry and switch card connectors coupled thereto;
at least one fabric interface card physically separate from the line cards and switch cards, the fabric interface card including fabric interface connectors, and fabric interface circuitry to manage transfers of information between the line cards and the switch cards; and
a backplane having connectors to receive the line cards, switch cards, and fabric interface card, wherein the backplane includes signal traces coupling the line interface and data processing circuitry on the line cards to the fabric interface circuitry on the fabric interface card, and coupling the fabric interface circuitry on the fabric interface card to the switch fabric circuitry on the switch cards.

2. The network system as in claim 1, further comprising:
a first interface including the signal traces coupling the line cards to the fabric interface card; and
a second interface including the signal traces coupling the fabric interface card to the switch cards.

3. The network system as in claim 2, wherein the first interface is a first extended length interface based on a OIF-SPI-4 standard which couples the line interface and data processing circuitry to the fabric interface circuitry via the line card connectors and fabric interface connectors respectively.

4. The network system as in claim 3, further comprising a termination network coupled to the signal traces proximate the fabric interface circuitry.

5. The network system as in claim 3, further comprising a termination network coupled to the signal traces proximate the line interface and data processing circuitry.

6. The network system as in claim 2, wherein the second interface is a second extended length interface based on a CSIX-L1 standard which couples the fabric interface circuitry to the switch fabric circuitry via the fabric interface connectors and switch card connectors respectively, wherein the second extended length interface has a length exceeding a length specified by the CSIX-L1 standard.

7. The network system as in claim 6, further comprising a termination network coupled to the signal traces proximate the fabric interface circuitry.

8. The network system as in claim 6, further comprising a termination network coupled to the signal traces proximate the line interface and data processing circuitry.

9. The network system as in claim 1, further comprising at least one CompactPCI (CPCI)-compliant system controller having CPCI-compliant system controller connectors, and wherein:
the line card connectors of at least one of the line cards comprises a non-CPCI-compliant pinout configuration to accommodate line card signals, including a selected set of signals from the CPCI-compliant system controller; and
the backplane connectors comprise backplane line card connectors and CPCI-compliant backplane system slot connectors to mate with the line card connectors and CPCI-compliant system controller connectors respectively, wherein the backplane couples the selected set of signals from the CPCI-compliant system controller to the line card via interconnecting signal traces between the CPCI-compliant backplane system slot connectors and the backplane line card connectors.

10. The network system as in claim 1, wherein the backplane connectors are positioned on one or more sides of the backplane.

11. The network system as in claim 1, wherein the fabric interface card comprises a fabric interface circuit implemented integrally with the backplane.

12. A method for interfacing circuits in a network routing system, comprising:
situating network line interface circuitry and switch fabric circuitry on one or more printed circuit boards;
situating fabric interface circuitry, which interfaces the network line interface circuitry to the switch fabric circuitry, on a fabric interface board distinct from the printed circuit boards associated with the network line interface and switch fabric circuitry;
connecting the one or more printed circuit boards to the fabric interface board; and
communicating information between the network line interface circuitry and the switch fabric circuitry via the distinct fabric interface board.

13. The method as in claim 12, wherein situating network line interfacing and switch fabric circuitry on one or more printed circuit boards comprises:
situating the network line interface circuitry on one or more line cards; and
situating the switch fabric circuitry on one or more switch cards.

14. The method as in claim 12, further comprising implementing a standard interface to connect the network line interface circuitry on the line cards and the fabric interface circuitry on the fabric interface board, wherein the standard interface is governed by a predefined standard otherwise not specified for coupling the line cards and the fabric interface board through connectors, and wherein the predefined standard specifies a maximum prescribed interface length which is less than a distance between the network line interface circuitry and the fabric interface circuitry, the method comprising:
extending the length of the standard interface beyond the maximum prescribed interface length specified by the predefined standard;
routing signal traces of the standard interface according to predetermined routing rules;
terminating the signal traces of the standard interface proximate a receiving one of the network line interface circuitry and the fabric interface circuitry; and
wherein the routing and terminating of the signal traces enables the standard interface between the line cards and fabric interface board to be extended beyond the maximum prescribed interface length.

15. The method as in claim 14, further comprising implementing connectors on the line cards and the fabric interface board that have impedances substantially matching a line impedance of the routed signal traces.

16. The method as in claim 14, wherein the predefined standard is an OIF-SPI-4 standard, and the standard interface is an OIF-SPI-4 interface.

17. The method as in claim 13, further comprising implementing a standard interface to connect the fabric interface circuitry on the fabric interface board and the switch fabric circuitry on the switch cards, wherein the standard interface is governed by a predefined standard otherwise not specified for coupling the fabric interface board and the switch cards through connectors, and wherein the predefined standard specifies a maximum prescribed interface length which is less than a distance between the fabric interface circuitry and switch fabric circuitry provided on the switch cards, the method comprising:
extending the length of the standard interface beyond the maximum prescribed interface length specified by the predefined standard;
routing signal traces of the standard interface according to predetermined routing rules;
terminating the signal traces of the standard interface proximate a receiving one of the fabric interface circuitry and the switch fabric circuitry; and
wherein the routing and terminating of the signal traces enables the standard interface between the fabric interface board and the switch cards to be extended beyond the maximum prescribed interface length.

18. The method as in claim 17, further comprising implementing connectors on the fabric interface board and the switch cards that have impedances substantially matching a line impedance of the routed signal traces.

19. The method as in claim 17, wherein the predefined standard is a CSIX-L1 standard, and the standard interface is a CSIX-L1 interface.

20. The method as in claim 13, wherein connecting the one or more printed circuit boards to the fabric interface board comprises connecting the one or more line cards and the one or more switch cards to the fabric interface board via direct cabling.

21. The method as in claim 13, wherein connecting the one or more printed circuit boards to the fabric interface board comprises connecting the one or more line cards and the one or more switch cards to the fabric interface board via a backplane.

22. A method for implementing a standard interface to connect network elements on different circuit boards, wherein the standard interface is governed by a predefined standard otherwise not specified for coupling network elements on different circuit boards that are connected through a backplane, and wherein the predefined standard specifies a maximum interface length which is less than a distance between the network elements, the method comprising:
extending the length of the standard interface beyond the maximum interface length specified by the predefined standard;
routing signal traces of the standard interface according to predetermined routing rules through circuit board and backplane connectors having impedances substantially corresponding to impedances of the signal traces;
terminating the signal traces of the standard interface proximate a receiving one of the network elements; and
wherein the routing and terminating of the signal traces enables the standard interface to be extended beyond the maximum specified interface length and through the connectors on the different circuit boards.

23. The method of claim 22, wherein the network elements on the different circuit boards comprise a traffic manager and a switch fabric, and wherein the predefined standard is the CSIX-L1 standard for interfacing the traffic manager to the switch fabric.

24. The method of claim 23, further comprising transmitting data from the traffic manager on a first circuit board to the switch fabric on a second circuit board, wherein the standard interface governed by the CSIX-L1 standard is coupled between the traffic manager and the switch fabric through the backplane, and through the circuit board and backplane connectors.

25. The method of claim 24, wherein transmitting data comprises transmitting data signals in parallel from the traffic manager to the switch fabric through the backplane, circuit board connectors, and backplane connectors.

26. The method of claim 23, further comprising transmitting data from the switch fabric on a second circuit board to the traffic manager on a first circuit board, wherein the standard interface governed by the CSIX-L1 standard is coupled between the switch fabric and the traffic manager through the backplane, and through the circuit board and backplane connectors.

27. The method of claim 26, wherein transmitting data comprises transmitting data signals in parallel from the switch fabric to the traffic manager through the backplane, circuit board connectors, and backplane connectors.

28. The method of claim 22, wherein the predefined standard is the OIF-SPI-4 standard for interfacing the network elements.

29. The method of claim 28, further comprising transmitting data from a first network element on a first circuit board to a second network element on a second circuit board, wherein the standard interface governed by the OIF-SPI-4 standard is coupled between the first and second network elements through the backplane, and through the circuit board and backplane connectors.

30. The method of claim 29, wherein transmitting data comprises transmitting data signals in parallel from the first network element to the second network element through the backplane, circuit board connectors, and backplane connectors.

31. The method of claim 22, wherein terminating the signal traces comprises coupling a termination network to the signal traces proximate the receiving one of the network elements.

32. The method of claim 31, wherein coupling a termination network to the signal traces comprises coupling termination elements to each of the signal traces.

33. The method of claim 22, further comprising transmitting data from a transmitting one of the network elements on a first circuit board to the receiving one of the network elements on a second circuit board, wherein the standard interface is coupled between the transmitting and receiving network elements through the backplane and the circuit board and backplane connectors.

34. The method of claim 33, wherein either of the network elements on the first and second circuit boards may be the transmitting network element or the receiving network element.

35. The method of claim 22, further comprising configuring and controlling the circuit boards utilizing a system controller that complies with a predefined local bus standard, wherein the system controller is coupled to the backplane according to the predefined local bus standard, and wherein the circuit boards configured and controlled by the system controller are not coupled to the backplane according to the predefined local bus standard.

36. The method of claim 35, wherein the predefined standard is a Compact Peripheral Component Interconnect (CPCI) standard.

37. The method of claim 36, further comprising assigning a pinout configuration to the local bus connectors on the circuit boards, wherein the pinout configuration and the local bus connectors on the circuit boards are not CPCI-compliant, and wherein a pinout configuration and connectors on the system controller are CPCI-compliant.

38. A method for implementing a Peripheral Component Interconnect (PCI) interface in a network system between at least one CompactPCI (CPCI)-compliant system controller and one or more peripheral cards that do not comply with the CPCI standard, the method comprising:
providing at least one system slot in a modular chassis that houses the network system, wherein the at least one system slot comprises backplane system slot connectors compliant with the CPCI standard to accept the CPCI-compliant system controller;
creating a pinout configuration on non-CPCI compliant peripheral card connectors to accommodate peripheral card signals, wherein the peripheral card signals include a selected set of signals from the CPCI-compliant system controller;
coupling the selected set of signals from the CPCI-compliant system controller to the peripheral cards by interconnecting signal traces on the backplane between the backplane system slot connectors and the peripheral card connectors; and
controlling the peripheral cards from the CPCI-compliant system controller.

39. The method as in claim 38, further comprising using PCI-to-PCI bridge components to increase the allowed length and number of leads of the PCI interface.

40. The method as in claim 38, further comprising excluding unused signals of the CPCI-compliant system controller from the backplane and the peripheral card connectors.

41. The method as in claim 38, further comprising utilizing a Eurocard form factor for the one or more peripheral cards to allow use of standard chassis components for peripheral card slots in the modular chassis.

42. The method as in claim 41, wherein the at least one peripheral card is dimensioned to a 9U height.

43. The method as in claim 38, further comprising distributing a plurality of voltages to the system controller and to the peripheral cards.

44. The method as in claim 43, further comprising distributing −48 volts to the peripheral cards independently from the distribution of the plurality of voltages.

45. The method as in claim 38, further comprising:
(a) implementing a standard interface to connect network elements on different ones of the peripheral cards, wherein the standard interface is governed by a predefined standard otherwise not specified for coupling network elements on different circuit boards that are connected through the backplane, and wherein the predefined standard specifies a maximum interface length which is less than a distance between the network elements;
(b) extending the length of the standard interface beyond the maximum interface length specified by the predefined standard;
(c) routing signal traces of the standard interface according to predetermined routing rules through the peripheral card and the backplane connectors, wherein the peripheral card and backplane connectors have impedances substantially corresponding to impedances of the signal traces; and
(d) terminating the signal traces of the standard interface on a receiving one of the peripheral cards proximate the corresponding network element.

46. The method of claim 45, wherein the network elements on the different peripheral cards comprises a traffic manager and a switch fabric, and wherein the predefined standard is the CSIX-L1 standard for interfacing the traffic manager to the switch fabric.

47. The method of claim 45, wherein the predefined standard for interfacing the network elements on the different peripheral cards is the OIF-SPI-4 standard.

48. A system for interfacing network elements on different circuit boards, comprising:
a first circuit board having a first network processor coupled thereto, and having one or more connectors substantially impedance-matched with first circuit board signal traces traversing the one or more connectors from the first network processor;
a second circuit board having a second network processor coupled thereto, and having one or more connectors substantially impedance-matched with second circuit board signal traces traversing the one or more connectors from the second network processor;
an interface circuit board arranged to receive and couple at least the first and second circuit board signal traces via interface signal traces and connectors that are substantially impedance-matched with the one or more connectors from the first and second circuit boards;
an extended-length interface based on a standard interface subject to a predefined standard, wherein the extended-length interface is subject to a set of routing rules not subject to the predefined standard and has a length greater than a length specified by the predefined standard, and wherein the extended-length interface couples the signal traces between the first and second network processors through the interface circuit board, the interface circuit board connectors, and the first and second circuit board connectors; and
a termination network coupled to the signal traces proximate a receiving one of the first and second network processors,
whereby the standard interface is employed to interface network processors on different circuit boards through connectors, although the standard interface is not specified therefor.

49. The system as in claim 48, wherein the standard interface subject to the predefined standard is a CSIX-L1 interface.

50. The system as in claim 49, wherein the first circuit board is a network line card and the first network processor is a traffic manager.

51. The system as in claim 49, wherein the first circuit board is a fabric interface card and the first network processor is a fabric interface processor.

52. The system as in claim 49, wherein the second circuit board is a switch card and the second network processor is a switch fabric.

53. The system as in claim 49, wherein:
(a) the first circuit board is a line card and the first network processor is a traffic manager;
(b) the second circuit board is a switch card and the second network processor is a switch fabric; and
(c) the interface circuit board is a backplane or midplane housed in a modular chassis in which the line card and the switch card are plugged in by way of the interface circuit board connectors and the first and second circuit board connectors.

54. The system as in claim 49, wherein:
(a) the first circuit board is a fabric interface card and the first network processor is a fabric interface processor;
(b) the second circuit board is a switch card and the second network processor is a switch fabric; and
(c) the interface circuit board is a backplane or midplane housed in a modular chassis in which the fabric interface card and the switch card are plugged in by way of the interface circuit board connectors and the first and second circuit board connectors.

55. The system as in claim 48, wherein the standard interface subject to the predefined standard is a OIF-SPI-4 interface.

56. The system as in claim 55, wherein the first and second circuit boards are network line cards, and wherein the interface circuit board is a backplane or midplane housed in a modular chassis in which the network line cards are plugged in through connection of the interface circuit board connectors and the first and second circuit board connectors.

57. The system as in claim 55, wherein the first circuit board is a network line card and the second circuit board is a fabric interface card, and wherein the interface circuit board is a backplane or midplane housed in a modular chassis in which the network line card and the fabric interface card are plugged in through connection of the interface circuit board connectors and the first and second circuit board connectors.

58. A system for interfacing a traffic manager and a switch fabric, comprising:
a line card having the traffic manager mounted thereon, wherein the line card comprises connectors substantially impedance-matched with line card signal traces traversing the connectors from the traffic manager;
a switch card having the switch fabric mounted thereon, wherein the switch card comprises connectors substantially impedance-matched with switch card signal traces traversing the connectors from the switch fabric;
a backplane arranged to receive and couple the line card and switch card signal traces via backplane signal traces and backplane connectors that are substantially impedance-matched with the connectors from the line card and the switch card;
an extended-length CSIX-L1 interface based on a CSIX-L1 standard, wherein the extended-length CSIX-L1 interface is subject to a set of routing rules not subject to the CSIX-L1 standard and has a length greater than a length specified by the CSIX-L1 standard, and wherein the extended-length CSIX-L1 interface couples the signal traces between the traffic manager and the switch fabric through the backplane, the backplane connectors, and the line card and switch card connectors; and
a termination network coupled to the signal traces proximate the switch card,
whereby the CSIX-L1 standard is employed to interface, through connectors, the traffic manager and the switch fabric on the line card and switch card respectively.

59. A system for interfacing a fabric interface processor and a switch fabric, comprising:
a fabric interface card having the fabric interface processor mounted thereon, wherein the fabric interface card comprises connectors substantially impedance-matched with fabric interface card signal traces traversing the connectors from the fabric interface processor;
a switch card having the switch fabric mounted thereon, wherein the switch card comprises connectors substantially impedance-matched with switch card signal traces traversing the connectors from the switch fabric;
a backplane arranged to receive and couple the fabric interface card and switch card signal traces via backplane signal traces and backplane connectors that are substantially impedance-matched with the connectors from the fabric interface card and the switch card;
an extended-length CSIX-L1 interface based on a CSIX-L1 standard, wherein the extended-length CSIX-L1 interface is subject to a set of routing rules not subject to the CSIX-L1 standard and has a length greater than a length specified by the CSIX-L1 standard, and wherein the extended-length CSIX-L1 interface couples the signal traces between the fabric interface processor and the switch fabric through the backplane, the backplane connectors, and the fabric interface card and switch card connectors; and
a termination network coupled to the signal traces proximate the switch card,
whereby the CSIX-L1 standard is employed to interface, through connectors, the fabric interface processor and the switch fabric on the fabric interface card and switch card respectively.

60. A system for interfacing network processors in a data directing system, comprising:
a first circuit card having a first network processor mounted thereon, wherein the first circuit card comprises first connectors substantially impedance-matched with first circuit card signal traces traversing the connectors from the first network processor;
a second circuit card having a second network processor mounted thereon, wherein the second circuit card comprises connectors substantially impedance-matched with second circuit card signal traces traversing the connectors from the second network processor;
a backplane arranged to receive and couple the first and second circuit card signal traces via backplane signal traces and backplane connectors that are substantially impedance-matched with the connectors from the first and second circuit cards;
an extended-length OIF-SPI-4 interface based on a OIF-SPI-4 standard, wherein the extended-length OIF-SPI-4 interface is subject to a set of routing rules not subject to the OIF-SPI-4 standard, and wherein the extended-length OIF-SPI-4 interface couples the signal traces between the first and second network processors through the backplane, the backplane connectors, and the first and second circuit card connectors; and
a termination network coupled to the signal traces proximate a receiving one of the first or second network processors,
whereby the OIF-SPI-4 standard is employed to interface, through connectors, the first and second network processors on the first and second circuit cards respectively.

61. A system for implementing a Peripheral Component Interconnect (PCI) interface in a network router, comprising:
a modular chassis to house the network router, wherein the modular chassis comprises at least one system slot and at least one peripheral card slot;
a CompactPCI (CPCI)-compliant system controller having CPCI-compliant system controller connectors;
at least one network peripheral card having matched impedance peripheral card connectors utilizing a non-CPCI-compliant pinout configuration to accommodate peripheral card signals, including a selected set of signals from the CPCI-compliant system controller; and
a backplane having backplane peripheral card connectors and CPCI-compliant backplane system slot connectors to mate with the peripheral card connectors and CPCI-compliant system controller connectors at the peripheral card slot and system slot respectively, wherein the backplane couples the selected set of signals from the CPCI-compliant system controller to the peripheral card via interconnecting signal traces between the CPCI-compliant backplane system slot connectors and the backplane peripheral card connectors.

62. The system as in claim 61, further comprising at least one PCI-to-PCI bridge coupled to increase an allowed length and number of leads of the PCI interface.
